(19) United States
(12) Patent Application Publication
(10) Pub. No.: US 2023/0019064 A1
(43) Pub. Date: Jan. 19, 2023

(54) METHODS AND SYSTEMS FOR RESOLVING DEPENDENCIES OF A DATA CENTER MODEL

(71) Applicant: VMWARE, INC., PALO ALTO, CA (US)

(72) Inventors: AMARJIT KUMAR GUPTA, Pune (IN); ABHIJIT SHARMA, Pune (IN); RAHUL AJIT CHAWATHE, BANGALORE (IN); GYAN SAGAR SINHA, PUNE (IN)

(21) Appl. No.: 17/476,502

(22) Filed: Sep. 16, 2021

(30) Foreign Application Priority Data
Jul. 14, 2021 (IN) 202141031607

(51) Int. Cl. H04L 12/24; H04L 12/26; G06F 16/28; G06F 9/455

(52) U.S. Cl. CPC H04L 41/12; H04L 41/0631; H04L 43/045; H04L 43/067; H04L 43/08; G06F 16/288; G06F 9/45558; G06F 2009/45595

(57) ABSTRACT

Methods and systems described herein are directed resolving object dependencies in a data center. A trie data structure that represents network paths of objects utilized by a selected source object is constructed. The trie data structure comprises nodes linked by edges. Each node represents an edge identification (“ID”) of source objects and destination objects of one or more network paths of objects utilized by the selected source object in a user-defined time interval. The trie data structure is traversed to resolve the different versions of source objects and destination objects utilized by the selected source object in subintervals of the time interval. A graph of the objects and destination objects utilized by the selected source object in the subintervals is generated and used to identify source objects and destination objects utilized by the selected source object during a performance problem of the selected source object.

### RELATED APPLICATION

Benefit is claimed under 35 U.S.C. 119(a)-(d) to Foreign Application Serial No. 202141031607 filed in India entitled “METHODS AND SYSTEMS FOR RESOLVING DEPENDENCIES OF A DATA CENTER MODEL”, on Jul. 14, 2021, by VMware, Inc., which is herein incorporated in its entirety by reference for all purposes.

### TECHNICAL FIELD

This disclosure is directed to methods and systems that resolve dependencies of a time-aware model of a hybrid virtual/physical data center network.

### BACKGROUND

Electronic computing has evolved from primitive, vacuum-tube-based computer systems, initially developed during the 1940s, to modern electronic computing systems in which large numbers of multi-processor computer systems, such as server computers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems include data centers and are made possible by advances in computer networking, distributed operating systems and applications, data-storage appliances, computer hardware, and software technologies. The number and size of data centers have continued to grow to meet the increasing demand for information technology (“IT”) services, such as running applications for organizations that provide business services, web services, and other cloud services to millions of customers each day.

Virtualization has made a major contribution toward moving an increasing number of cloud services to data centers by enabling creation of software-based, or virtual, representations of server computers, data-storage devices, and networks. For example, a virtual computer system, also known as a virtual machine (“VM”), is a self-contained application and operating system implemented in software. Unlike applications that run on a physical computer system, a VM may be created or destroyed on demand, may be migrated from one physical server computer to another in a data center, and based on an increased demand for services provided by an application executed in a VM, may be cloned to create multiple VMs that run on one or more physical server computers. Network virtualization has enabled creation, provisioning, and management of virtual networks implemented in software as logical networking devices and services, such as logical ports, logical switches, logical routers, logical firewalls, logical load balancers, virtual private networks (“VPNs”) and more to connect workloads. Network virtualization allows applications and VMs to run on a virtual network and has enabled the creation of software-defined data centers within a physical data center. As a result, many organizations no longer make expensive investments in building and maintaining physical computing infrastructures. Virtualization has proven to be an efficient way of reducing IT expenses for many organizations while increasing computational efficiency, access to cloud services, and agility for all size businesses, organizations, and customers.

With the increasing size of data centers and use of virtualization, network troubleshooting tools have been developed to aid administrators with monitoring virtual and physical networks and improve network reliability and security. Network troubleshooting tools typically build a time-aware model of a hybrid virtual/physical data center network. The time-aware model is an abstraction of various versions of objects on the hybrid data center network and relationships between the objects at different points in times. The time-aware model is persisted in a data center database. For example, a time-aware model may be used to check the version and/or network connections of a VM of a distributed application at different points in time. Because a typical data center may run millions of VMs, a time-aware model of the data center network requires an immense amount of data storage and the full time-aware model is fetched from the data center database to check the status of objects on the data center network. However, maintaining and fetching the time-aware model from the database is expensive and to store the model in memory of a host already running VMs and applications results in excessive memory overhead, which requires additional allocation of overhead memory to temporarily store the model. As a result, fetching and storing a time-aware model often results in a reduction in the amount of overhead memory available to VMs and applications running on the host. For example, VMs typically require overhead memory to be available to power on. When the overhead memory is filled with a time-aware model, VMs cannot be restarted. Administrators and application owners seek methods and systems that reduce the number of calls to fetch a time-aware model and reduce the need to access memory overheads and maintain access to overhead memory for essential objects.

### SUMMARY

Computer-implemented methods and systems described herein are directed to resolving object dependencies in a data center. In particular, computer-implemented methods and systems construct a trie data structure that represents network paths of objects utilized by a selected source object. The trie data structure comprises nodes linked by edges. Each node comprises an edge identification (“ID”) of source objects and destination objects of the one or more network paths of objects utilized by the selected source object in a user selected time interval. Computer implemented methods and systems traverse the trie data structure to resolve the different versions of source objects and destination objects utilized by the selected source object in subintervals of the time interval. The methods and systems also generate a graph of the objects and destination objects utilized by the selected source object in the subintervals. The graph is used to identify source objects and destination objects utilized by the selected source object during a performance problem of the selected source object. Methods and systems use the graph and subintervals to identify objects that were used during the performance problem and execute remedial measures to correct the performance problem.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine (“VM”) and VM execution environments.

FIG. 6 shows an example of an open virtualization format package.

FIG. 7 shows virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing the containers on a VM.

FIG. 13 shows generalized hardware and software components that form virtual networks from a general-purpose physical network.

FIGS. 14A-14B show a physical layer of a data center and a virtual layer.

FIG. 15 shows examples of dependencies for a typical VM running in a data center.

FIG. 16A shows an example of six network paths from the VM to dependencies shown in FIG. 15.

FIG. 16B shows examples of destination objects of each of the dependencies shown FIG. 16A.

FIG. 16C shows an example graph of destination entities of the VM and subintervals of the time interval in which the VM depends on the destination entities.

FIG. 17A shows a simple example of network paths for an object running on a host server computer in a data center.

FIGS. 17B-17D show three example network paths.

FIG. 18A shows an example graphical user interface that enables a user to select a source object from a list of data center objects and input a start time and an end time for a time interval.

FIG. 18B shows an example of four separate network paths for a selected source object in the example GUI of FIG. 18A.

FIG. 18C shows examples of edge IDs formed from edges of four network paths shown in FIG. 18A.

FIGS. 19A-19E show an example of linking a set of edge IDs to form a trie data structure for network paths shown in FIG. 18B.

FIG. 20 shows an example trie data structure with edge IDs represented as nodes linked by edges.

FIGS. 21A-21F show an example of resolving source objects and destination objects of the example trie data structure over subintervals of the time interval.

FIG. 22 shows an example graphical user interface that displays an example graph of the selected source object and dependent objects.

FIG. 23 is a flow diagram of a method for resolving dependencies of a selected source object of data center.

FIG. 24 is a flow diagram illustrating an example implementation of the “construct a trie data structure based on object types and network paths” procedure performed in block 2301 of FIG. 23.

FIG. 25 is a flow diagram illustrating an example implementation of the “resolve resultant objects of the object types in the trie data structure” procedure performed in block 2302 of FIG. 23.

FIG. 26 is a flow diagram illustrating an example implementation of the “resolve objects of the object type” procedure performed in block 2505 of FIG. 25.

### DETAILED DESCRIPTION

This disclosure presents computer-implemented methods and systems for resolving dependencies of a time-aware model of a hybrid virtual/physical data center network. In a first subsection, computer hardware, complex computational systems, and virtualization are described. Network virtualization is described in a second subsection. Computer-implemented methods and systems for resolving dependencies of a time-aware model of a hybrid virtual/physical data center network are described below in a third subsection.

### Computer Hardware, Complex Computational Systems, and Virtualization

The term “abstraction” does not mean or suggest an abstract idea or concept. Computational abstractions are tangible, physical interfaces that are implemented using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. Software is a sequence of encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices. Multi-cloud aggregations, cloud-computing services, virtual-machine containers and virtual machines, containers, communications interfaces, and many of the other topics discussed below are tangible, physical components of physical, electro-optical-mechanical computer systems.

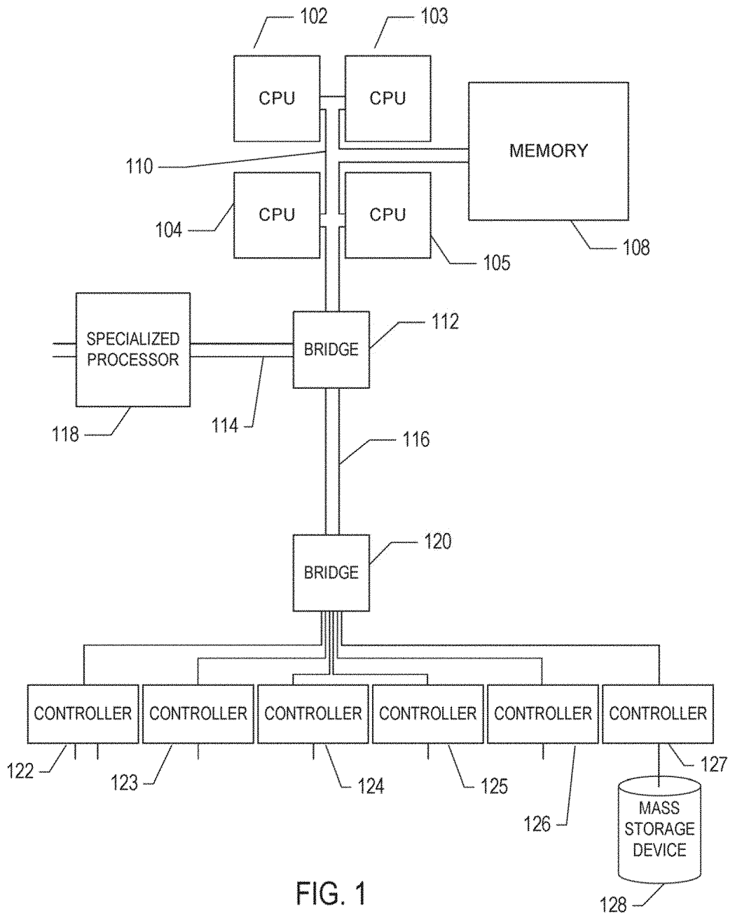

FIG. 1 shows a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

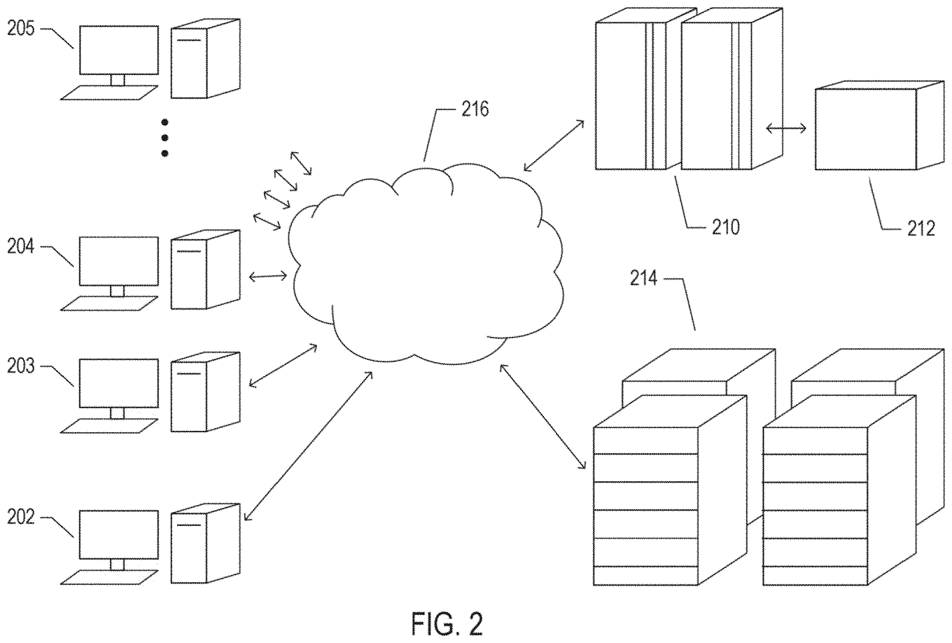

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

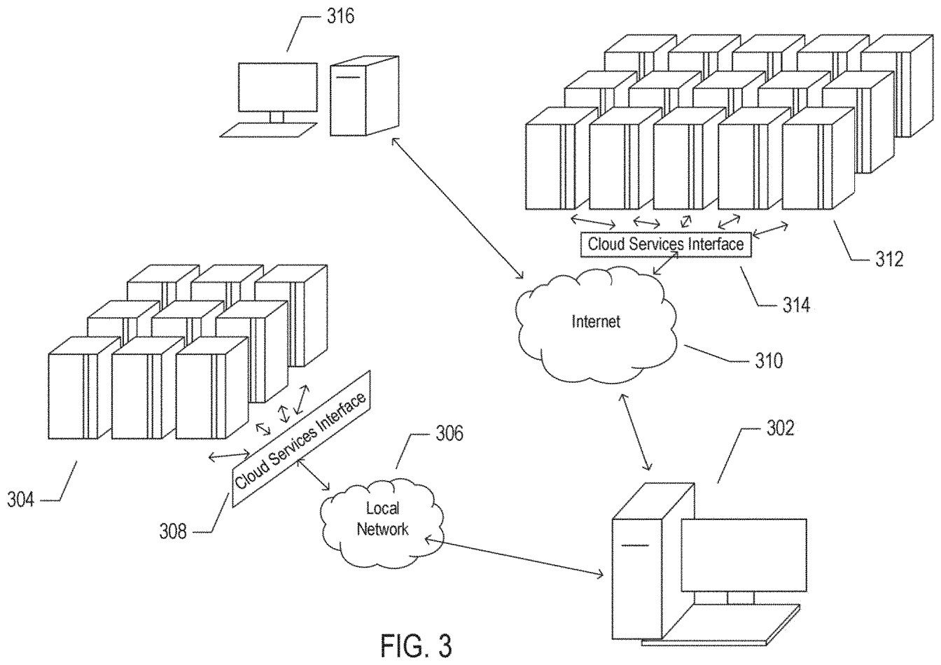

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

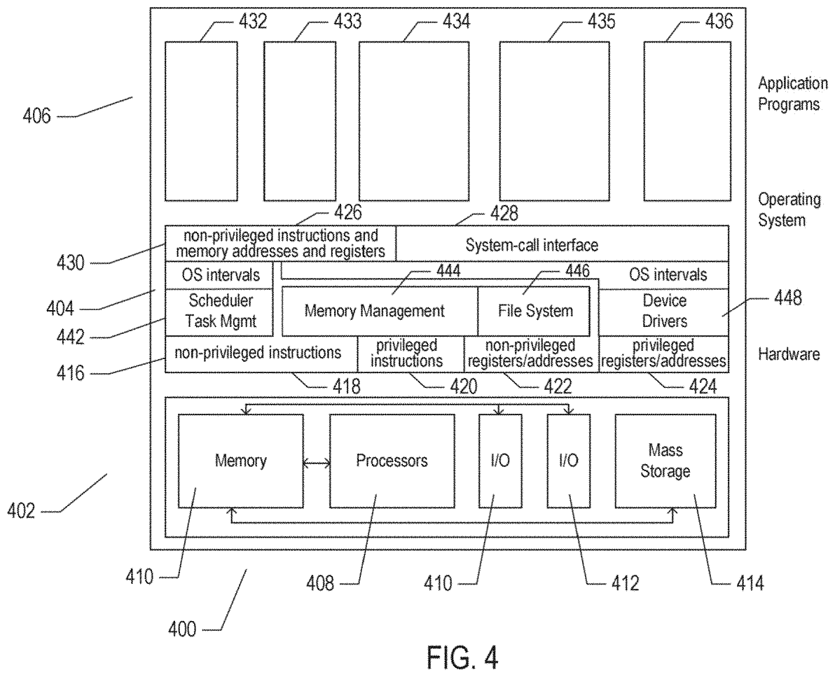

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

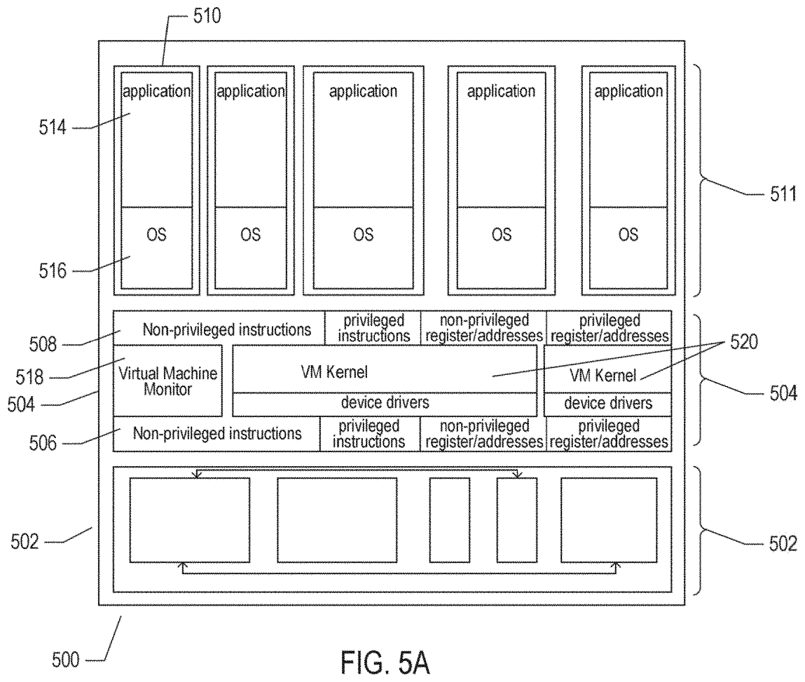

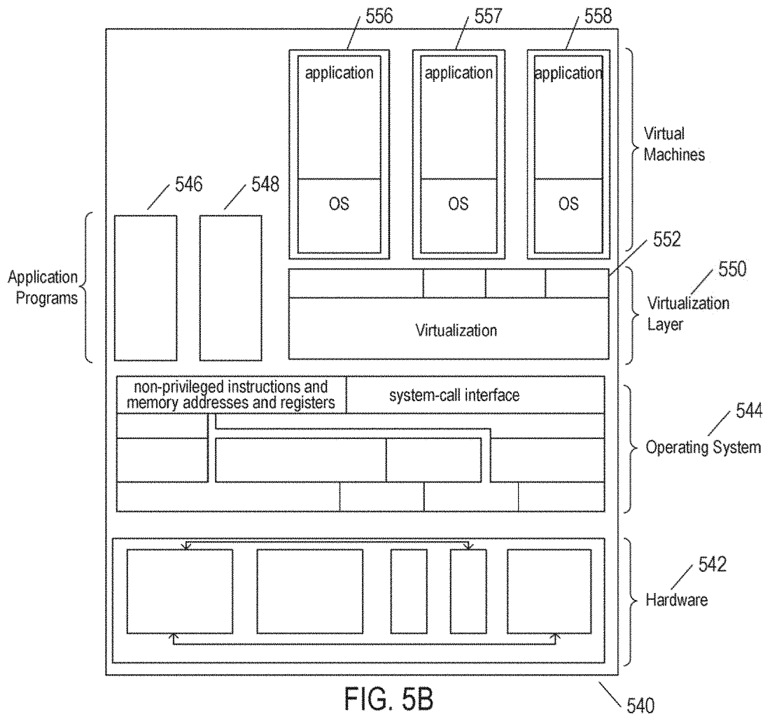

For the above reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtual layer 504 that interfaces through a virtualization-layer/hardware-layer interface 506, equivalent to interface 416 in FIG. 4, to the hardware. The virtual layer 504 provides a hardware-like interface to many VMs, such as VM 510, in a virtual-machine layer 511 executing above the virtual layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtual layer interface 504 rather than to the actual hardware interface 506. The virtual layer 504 partitions hardware devices into abstract virtual-hardware layers to which each guest operating system within a VM interfaces. The guest operating systems within the VMs, in general, are unaware of the virtual layer and operate as if they were directly accessing a true hardware interface. The virtual layer 504 ensures that each of the VMs currently executing within the virtual environment receive a fair allocation of underlying hardware devices and that all VMs receive sufficient devices to progress in execution. The virtual layer 504 may differ for different guest operating systems. For example, the virtual layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtual layer 504 includes a virtual-machine-monitor module 518 (“VMM”), also called a “hypervisor,” that virtualizes physical processors in the hardware layer to create virtual processors on which each of the VMs executes. For execution efficiency, the virtual layer attempts to allow VMs to directly execute non-privileged instructions and to directly access non-privileged registers and memory. However, when the guest operating system within a VM accesses virtual privileged instructions, virtual privileged registers, and virtual privileged memory through the virtual layer 504, the accesses result in execution of virtualization-layer code to simulate or emulate the privileged devices. The virtual layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtual layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtual layer 550 is also provided, in computer 540, but, unlike the virtual layer 504 discussed with reference to FIG. 5A, virtual layer 550 is layered above the operating system 544, referred to as the “host OS,” and uses the operating system interface to access operating-system-provided functionality as well as the hardware. The virtual layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtual layer 550 may reside within the host-operating-system kernel, such as a specialized driver incorporated into the host operating system to facilitate hardware access by the virtual layer.

It should be noted that virtual hardware layers, virtual layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtual layers, and guest operating systems are abstract or intangible. Virtual hardware layers, virtual layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

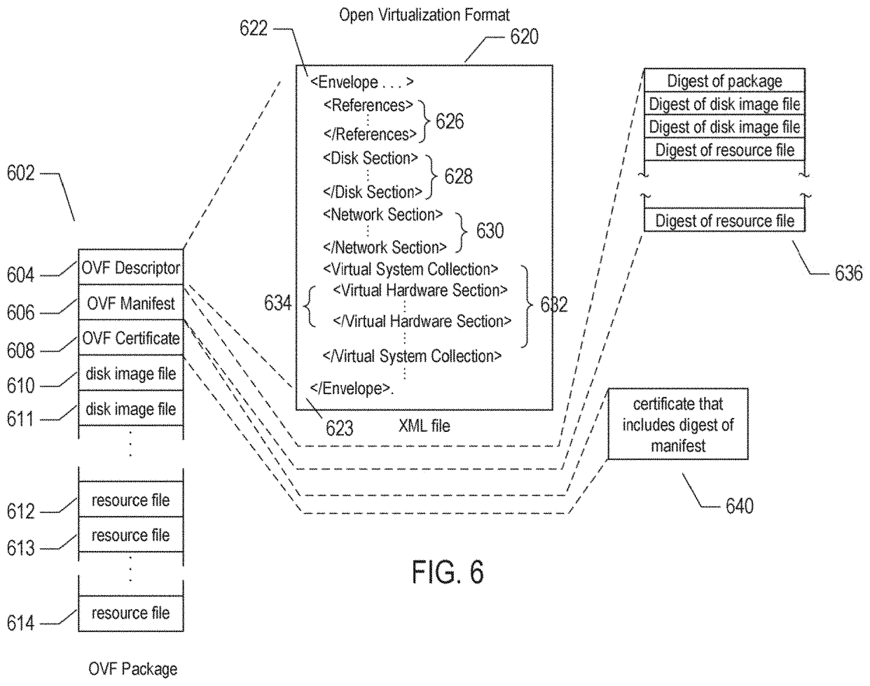

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtual layers running on many different types of computer hardware. A next level of abstraction, referred to as virtual data centers or virtual infrastructure, provide a data-center interface to virtual data centers computationally constructed within physical data centers.

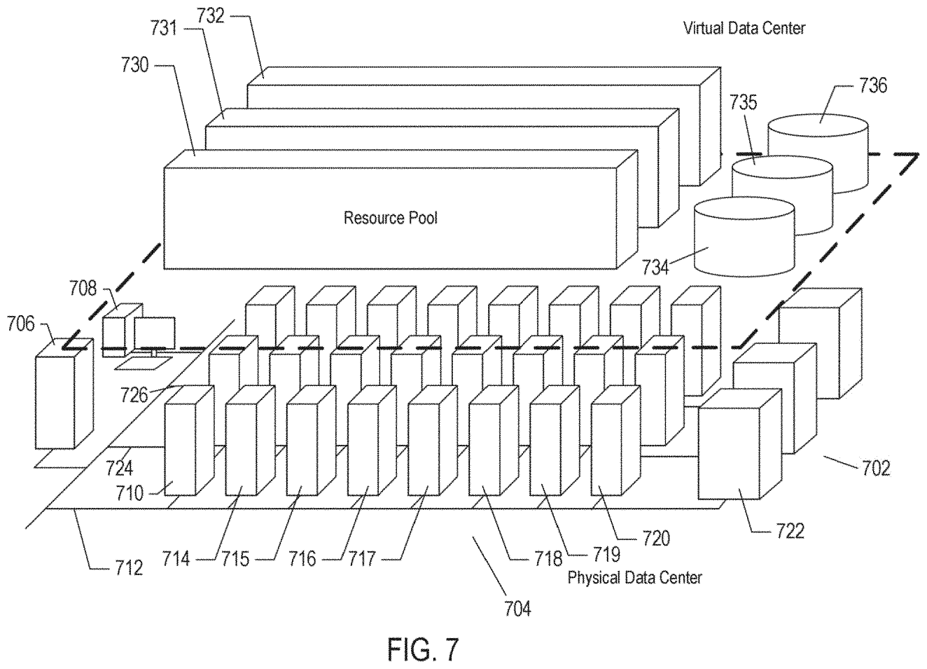

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtual layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

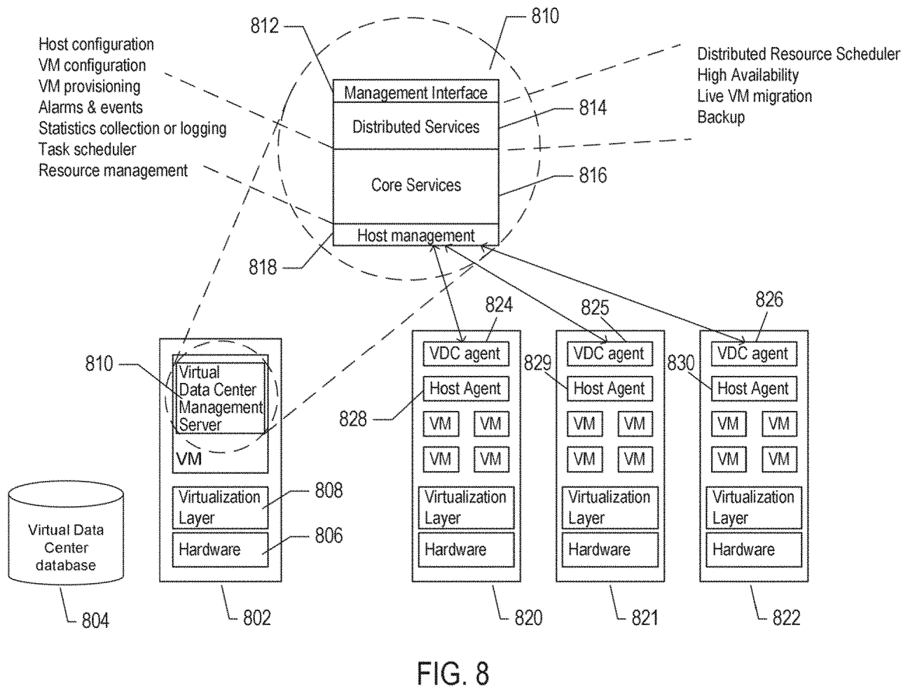

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtual layer 808, and runs a virtual-data-center management-server VM 810 above the virtual layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtual layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

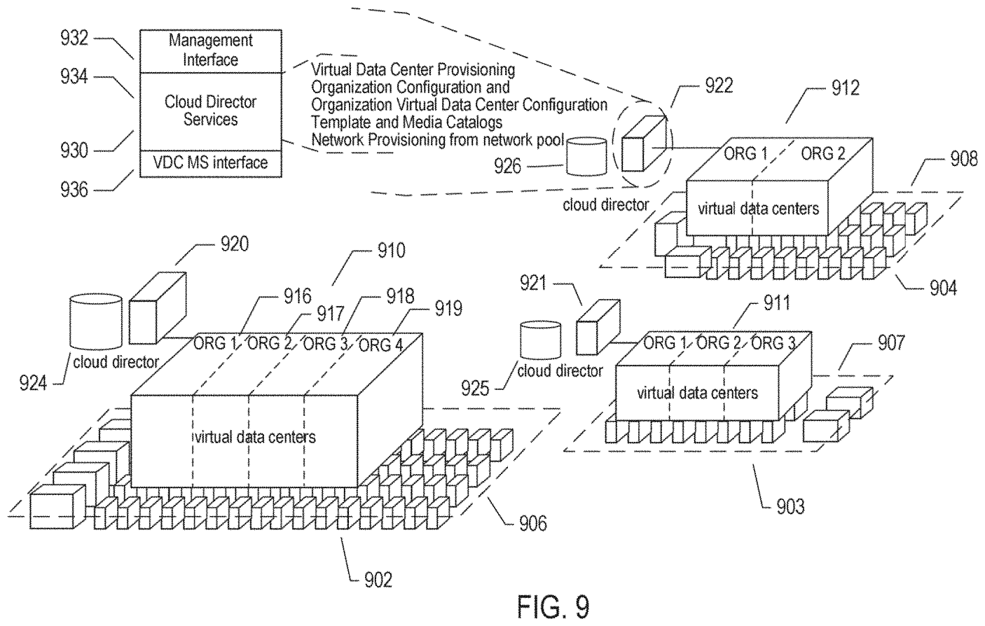

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

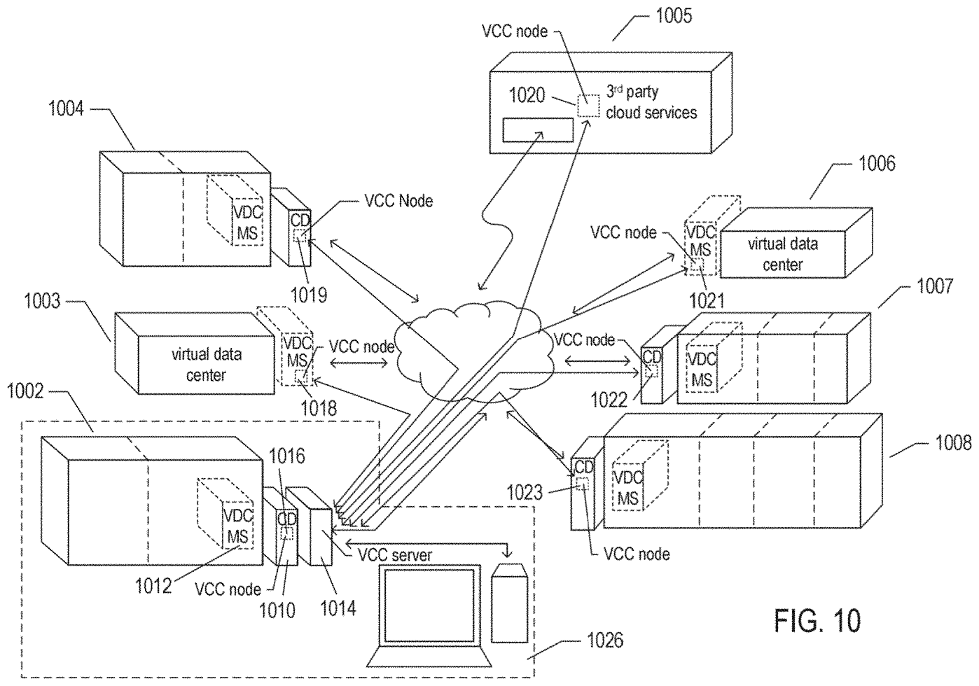

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtual layers, described in the previous subsection, have received widespread adoption and use in a variety of different environments, from personal computers to enormous distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtual layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files not included the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtual layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

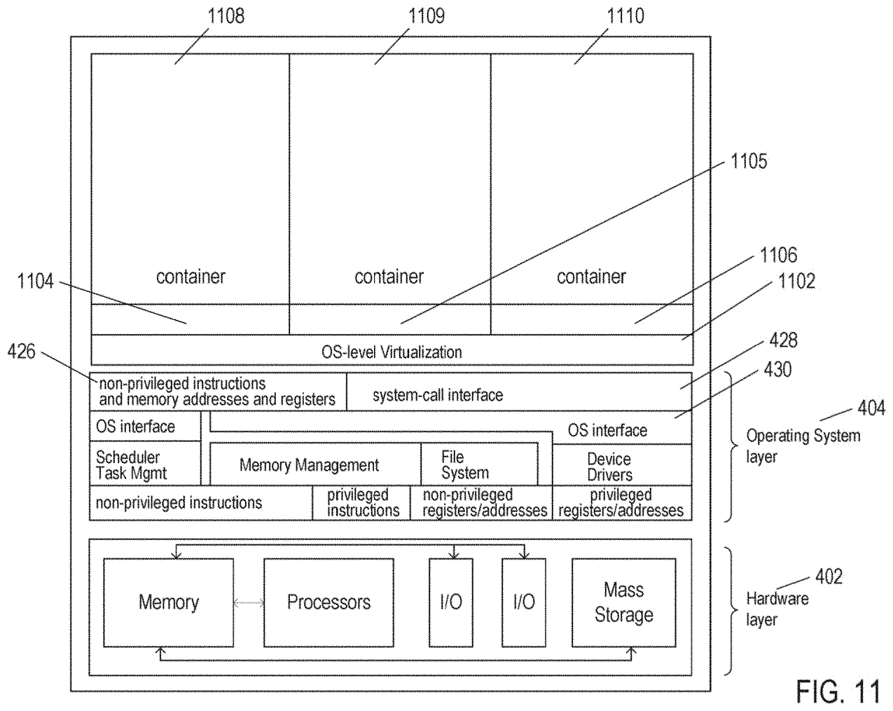

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtual layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

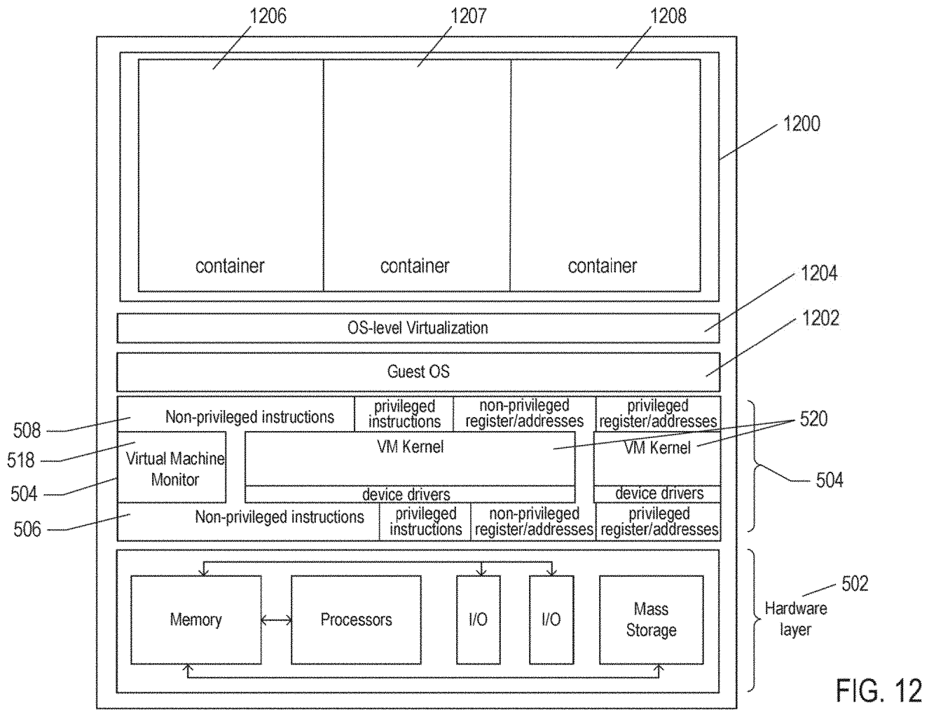

FIG. 12 shows an approach to implementing the containers on a VM. FIG. 12 shows a host computer similar to that shown in FIG. 5A, discussed above. The host computer includes a hardware layer 502 and a virtual layer 504 that provides a virtual hardware interface 508 to a guest operating system 1102. Unlike in FIG. 5A, the guest operating system interfaces to an OSL-virtual layer 1104 that provides container execution environments 1206-1208 to multiple application programs.

Note that, although only a single guest operating system and OSL virtual layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtual layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted to provide additional execution environments and associated resources for additional application instances. The resources available to the guest operating system are efficiently partitioned among the containers provided by the OSL-virtual layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtual layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtual layer and the advantages of OSL virtualization.

### Network Virtualization

A physical network comprises physical switches, routers, cables, and other physical devices that transmit data within a data center. A logical network is a virtual representation of how physical networking devices appear to a user and represents how information in the network flows between objects connected to the network. The term “logical” refers to an IP addressing scheme for sending packets between objects connected over a physical network. The term “physical” refers to how actual physical devices are connected to form the physical network. Network virtualization decouples network services from the underlying hardware, replicates networking components and functions in software, and replicates a physical network in software. A virtual network is a software-defined approach that presents logical network services, such as logical switching, logical routing, logical firewalls, logical load balancing, and logical private networks to connected workloads. The network and security services are created in software that uses IP packet forwarding from the underlying physical network. The workloads are connected via a logical network, implemented by an overlay network, which allows for virtual networks to be created in software. Virtualization principles are applied to a physical network infrastructure to create a flexible pool of transport capacity that can be allocated, used, and repurposed on demand.

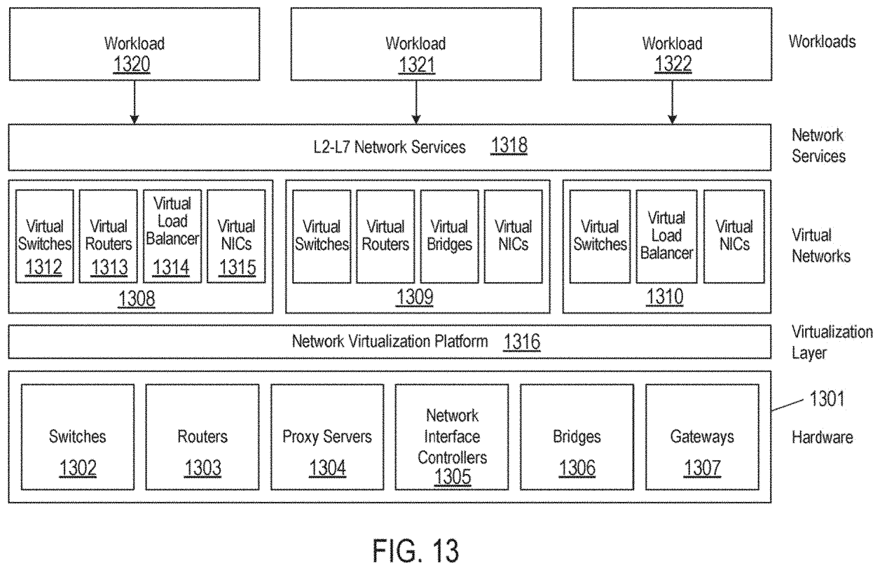

FIG. 13 shows generalized hardware and software components that form virtual networks from a general-purpose physical network. The physical network is a hardware layer 1301 that includes switches 1302, routers 1303, proxy servers 1304, network interface controllers 1305, bridges 1306, and gateways 1307. Of course, the physical network may also include many other components not shown, such as power supplies, internal communications links and busses, specialized integrated circuits, optical devices, and many other components. In the example of FIG. 13, software components form three separate virtual networks 1308-1310 are shown. Each virtual network includes virtual network devices that execute logical compute services. For example, virtual network 1308 includes virtual switches 1312, virtual routers 1313, virtual load balancer 1314, and virtual network interface cards (“vNICs”) 1315 that provide logical switching, logical routing, logical firewall, and logical load balancing services. The virtual networks 1308-1310 interface with components of the hardware layer 1301 through a network virtualization platform 1316 that provisions physical network services, such as L2-L7 network systems interconnection (“OSI”) services, to the virtual networks 1308-1310, creating L2-L7 network services 1318 for connected workloads. For example, the virtual switches, such as virtual switches 1312, may provide L2, L3, access control list (“ACL”), and firewall services. In FIG. 13, the virtual networks 1308-1310 provide L2-L7 network services 1318 to connected workloads 1320-1322. VMs, containers, and multi-tier applications generate the workloads 1320-1322 that are sent using the L2-L7 network services 1318 provided by the virtual networks 1308-1310.

FIGS. 14A-14B show an example of objects of a physical layer of a data center and objects of a virtual layer, respectively. In FIG. 14A, a physical data center 1402 comprises a management server computer 1404 and any of various computers, such as PC 1406, on which a virtual-data-center management interface may be displayed to system administrators and other users. Objects of the physical data center 1402 additionally includes hosts or server computers, such as server computers 1408-1411, mass-storage devices, such as a mass-storage device 1412, switches 1414 and 1416, and a top of rack (“TOR”) switch 1418 that connects the server computers and mass-storage devices to the Internet, the virtual-data-center management server 1404, the PC 1406, and other server computers and mass-storage arrays (not shown). In the example of FIG. 14A, each of the switches 1414 and 1416 interconnects four server computers and a mass-storage device to each other and connects the server computers and the mass-storage devices to the TOR switch 1418. For example, the switch 1414 interconnects the four server computers 1408-1411 and the mass-storage device 1412 to a TOR switch 1418 that is in turn connected to the switch 1416, which interconnects four server computers 1422-1425 and a mass-storage device 1426. The example physical data center 1402 is provided as an example of a data center. Physical data centers may include a multitude of server computers, networks, data-storage systems and devices connected according to many different types of connection topologies.

In FIG. 14B, a virtual layer 1428 is separated from the physical data center 1402 by a virtual-interface plane 1430. The virtual layer 1428 includes virtual objects, such as VMs, containers, and virtual components of three example virtual networks 1432-1434, hosted by the server computers of the physical data center 1402. Each virtual network has a network edge that is executed in a VM and serves as a platform for maintaining the corresponding virtual network services, such as a corresponding firewall, switch, and load balancing. Each virtual network includes a virtual switch that interconnects VMs of an organization to a virtual storage and to a virtual router 1436. For example, virtual network 1433 comprises VMs 1438-1441 that run different components of a distributed application and virtual storage 1442 interconnected by a virtual switch 1444 that is connected to the virtual router 1436. In the example of FIG. 14B, firewalls 1448-1450 provide network security by controlling incoming and outgoing network traffic to the virtual networks 1433-1435 based on predetermined security rules. In this example, the network edge of the virtual network 1434 executes a load balancer 1452 that evenly distributes workloads to the VMs connected to the virtual network. FIG. 14B also shows a network management server 1454 that is hosted by the management computer server 1404, maintains network policies, and executes the methods described below. The virtual layer 1428 is provided as an example virtual layer. Different virtual layers include many different types of virtual switches, virtual routers, virtual ports, and other virtual objects connected according to many different types of network topologies.

Functionality of a data center network is characterized in terms of network traffic and network capacity. Network traffic is the amount data moving through a network at any point in time and is typically measured as a data rate, such as bits, bytes or packets transmitted per unit time. Throughput of a network channel is the rate at which data is communicated from a channel input to a channel output. Capacity of a network channel is the maximum possible rate at which data can be communicated from a channel input to a channel output. Capacity of a network is the maximum possible rate at which data can be communicated from channel inputs to channel outputs of the network. The availability and performance of distributed applications executing in a data center largely depends on the data center network successfully passing data over data center virtual networks.

Network troubleshooting tools are run on the management server computer 1404. Network troubleshooting tools, such as vRealize Network Insight by VMware Inc., build a time-aware model of a hybrid virtual/physical data center network. The time-aware model is an abstraction of various versions of objects on the hybrid data center network and of relationships between the objects at different points in times. The time-aware model is persisted in a data center database. A time-aware model may be used to determine network connections of different objects of a distributed computing system at different points in time. System administrators perform interactive troubleshooting of a network problem with network troubleshooting tools based on the time-aware model. For example, an administrator trying to troubleshoot a network problem associated with a VM must repeatedly access a time-aware model of the data center to determine intermediary objects that are connected to the VM and determine dependencies of the VM at different points in time. Dependencies are objects of the data center that depend on another object of the data center. For example, a dependency is created by an object that depends on switch ports of switches to transmit and receive data.

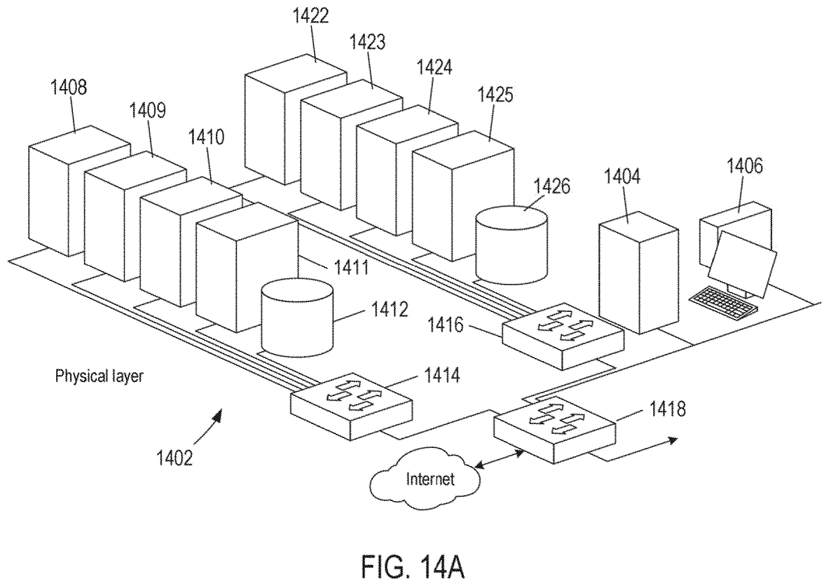

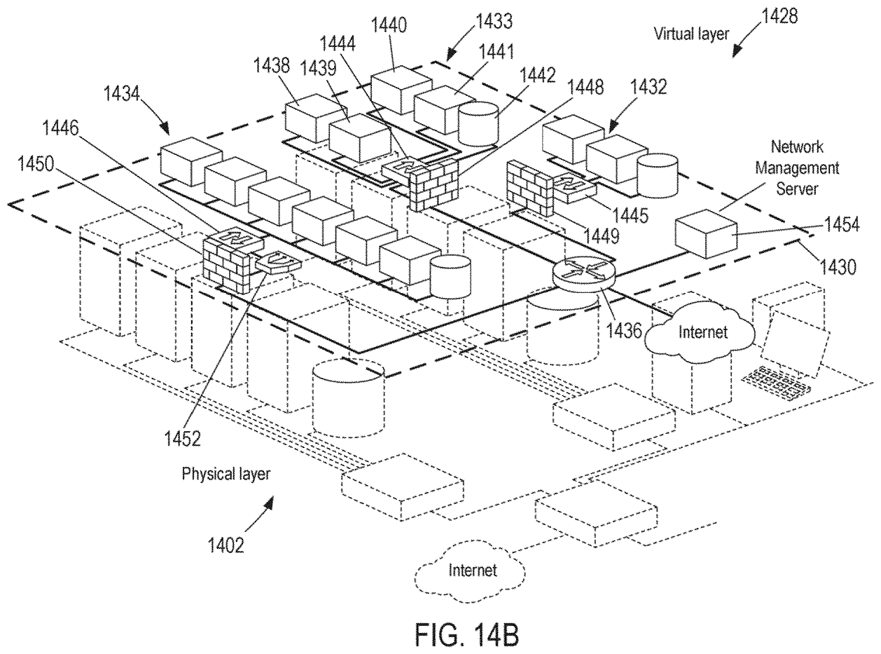

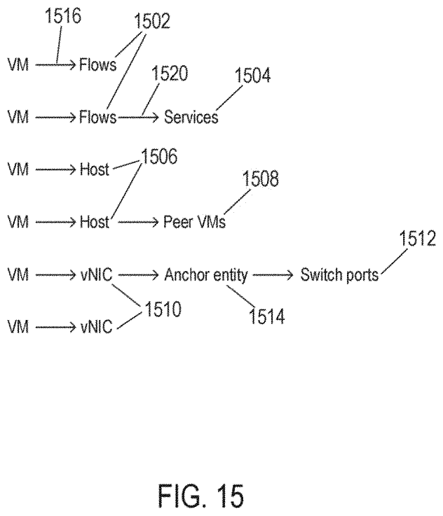

FIG. 15 shows examples of dependencies for a typical VM 1500 running in a data center. Flows 1502 represents capacities of network channels that send data to and receive data from the VM. Services 1504 represent services provided by the VM to users. Host 1506 represents one or more server computers that are used to host the VM. Peer VMs 1508 are equally privileged participants in execution of a distributed application. Virtual NIC 1510 represents vNICs the VM uses to send and receive data. Switch ports 1512 represents switch ports of a switch and/or TOR switch located in the same rack of server computers as the host 1506 and are used by the VM. Anchor entity 1514 represents intermediary entities in a database. The directional arrows indicate dependencies. For example, directional arrow 1516 represents the VM depends on the flows 1502. Directional arrows 1518 and 1520 represent how the VM depends on the flows 1520 which, in turn, depend on the services 1504.

In a real-life data center, there may be thousands of flows 1502 for a single VM. Likewise, if the VM runs a component of a distributed application, there may be thousands of peer VMs 1508. The network connections between the VM and versions of dependent objects may change at different points in time. A time-aware model of the objects running in a data center network requires a large amount of data storage to maintain a record of these different objects and their network connections at different points in time. Because a typical data center may execute millions of applications, containers, and VMs, a time-aware model of objects on a data center network requires an immense amount of data storage. During troubleshooting of a network problem, a full time-aware model is repeatedly fetched from the data base. However, maintaining and fetching the full time-aware model from the database is expensive and to temporarily store the time-aware model in memory of a host often uses overhead memory, which disrupts performance of other VMs and applications that may be running on the host. In addition, interactive troubleshooting of a network problem can take days and weeks to perform with typical network troubleshooting tools based on the full time-aware model.

### Computer-Implemented Methods and Systems for Resolving Dependencies of a Time-Aware Model of a Hybrid Virtual/Physical Data Center Network

Computer-implemented methods and systems described herein resolve dependencies of a type of object (i.e., “object type”) selected for troubleshooting in real time, thereby enabling troubleshooting of network problems in a much shorter period of time than with conventional interactive troubleshooting. In other words, computer-implemented methods and systems eliminate storage and repeated access to a full time-aware model of a data center to determine dependencies of an object type selected for troubleshooting.

Computer-implemented methods described herein determine a set of destination objects for a given source object type denoted by S, a time interval denoted by (tₛₜₐᵣₜ-t_{end}), where tₛₜₐᵣₜ is the beginning of the time range and t_{end} is the end of the time interval, and a set of n network paths denoted by {P₀, P₁, . . . , Pₙ} obtained from the time-aware model. The set of destination objects and object types are denoted by

{(d₀₁,d₀₂, . . . ),(d₁₁,d₁₂, . . . ), . . . ,(dₙ₁dₙ₂, . . . )}

where
dᵢⱼ represents an i-th object of a j-th object type;
(d₀₁,d₀₂, . . . ) represents objects of a zeroth object type;
(d₁₁,d₁₂, . . . ) represent objects of a first object type; and
(dₙ₁,dₙ₂, . . . ) represented objects of an n-th object type.
   The object types are dependencies of the given source object type S.

Computer-implemented methods and systems described below resolve dependencies of object types by determining subintervals of the time interval (tₛₜₐᵣₜ-t_{end}) in which particular destination objects of the object types depend on sending data to or receiving data from the source object type. The destination objects and associated subintervals may be used in troubleshooting to aid with identification of destination objects associated with a problem at the object.

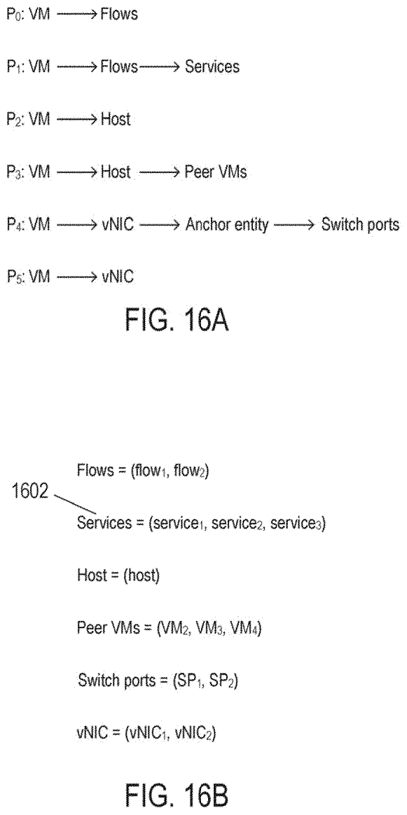

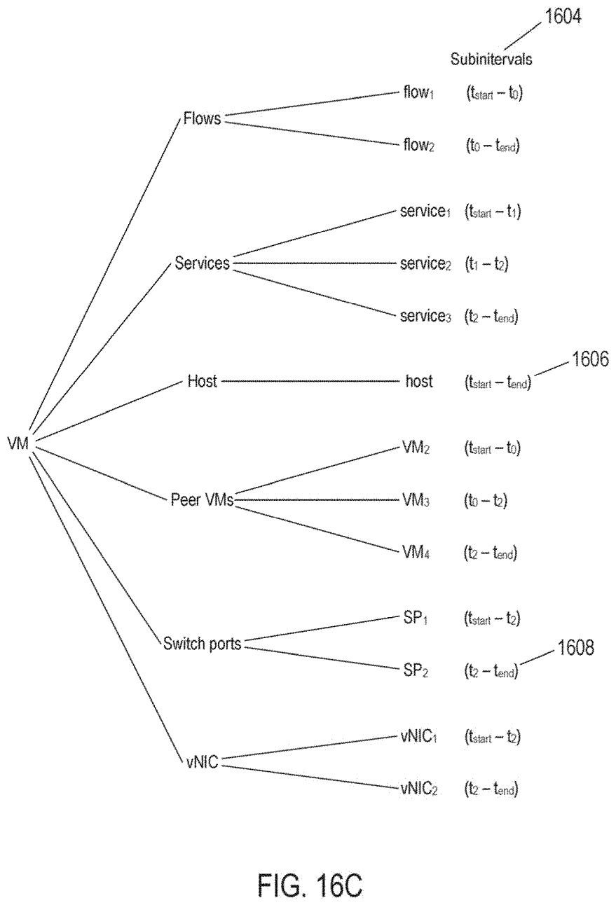

FIG. 16A shows an example of six paths from a VM object type to different object types shown in FIG. 15 over a time interval (tₛₜₐᵣₜ-t_{end}) The six paths are denoted by P₀, P₁, P₂, P₃, P₄ and P₅. FIG. 16B shows examples of destination object types of each of the dependencies shown FIG. 16A. For example, the dependency Services 1602 is an object type that includes three objects denoted by service₁, service₂, and service₃. Services serivce₁, service₂, and service₃ may be associated with different subintervals (tₛₜₐᵣₜ-t₀), (t₀-t₁) and (t₁-t_{end}), respectively, where times t₀ and t₁ represent different times between tₛₜₐᵣₜ and t_{end}. In other words, serivce₁, service₂, and service₃ depend on the VM object type in corresponding subintervals (tₛₜₐᵣₜ-t₀), (t₀-t₁) and (t₁-t_{end}).

FIG. 16C shows an example graph of destination objects of the VM object type and subintervals of the time interval (tₛₜₐᵣₜ-t_{end}) in which the VM object type depends on the destination objects. Subintervals 1604 of the time interval (tₛₜₐᵣₜ-t_{end}) in which the destination objects depend on the VM object type are listed next to each destination object, where tₛₜₐᵣₜ<t₀<t₁<t₂<t_{end}. For example, the VM object type depends on the VM₂ in subinterval 1606 and depends on the switch port SP₂ in subinterval 1608. Computer-implemented methods and systems described herein determine the destination objects and associated subintervals shown in the example of FIG. 16C. The graph is used in troubleshooting to aid with identification of one or more objects that may be associated with a performance problem with the VM. For example, let tₚ be a time in which a problem has been detected with the VM and tₛₜₐᵣₜ<tₚ<t₀. Computer-implemented methods output flow₁, service₁, host, VM₂, SP₁, and vNIC₁ as objects in which time tₚ lies within associated subintervals, which reduces the overall list of objects from thirteen to six. Any one or more of the six objects may be associated with the problem at the VM.

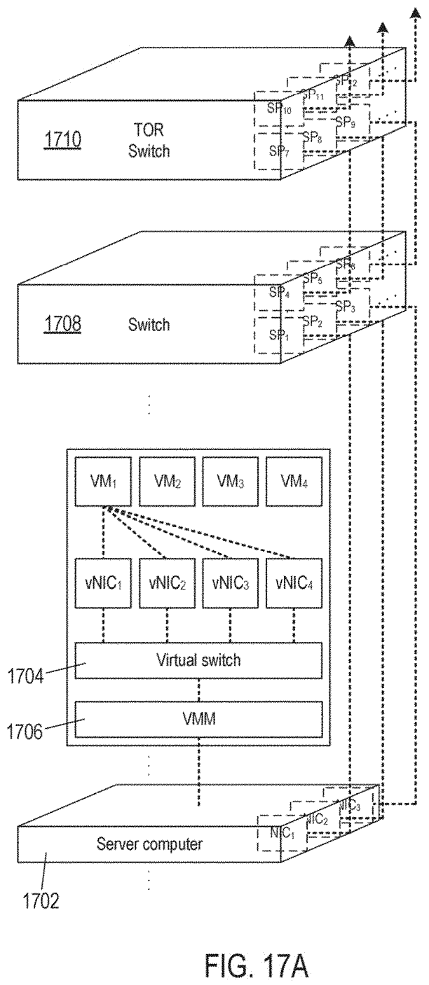

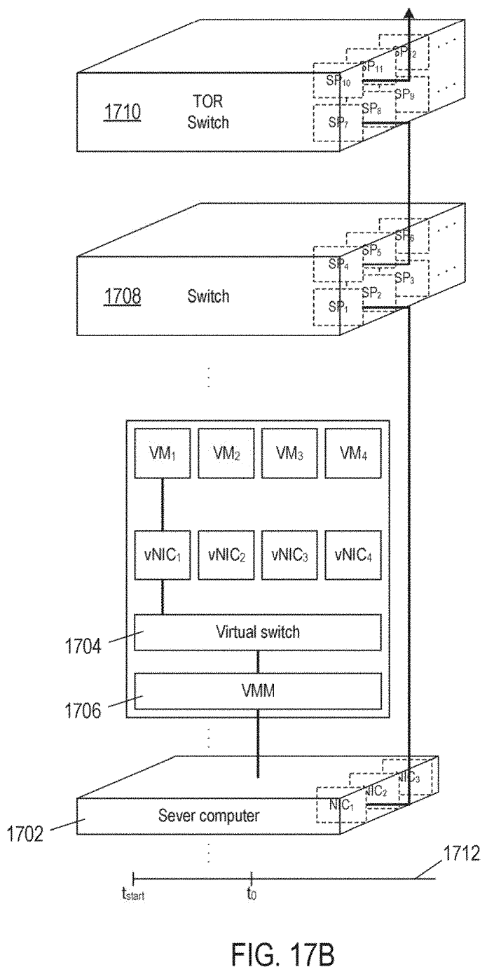

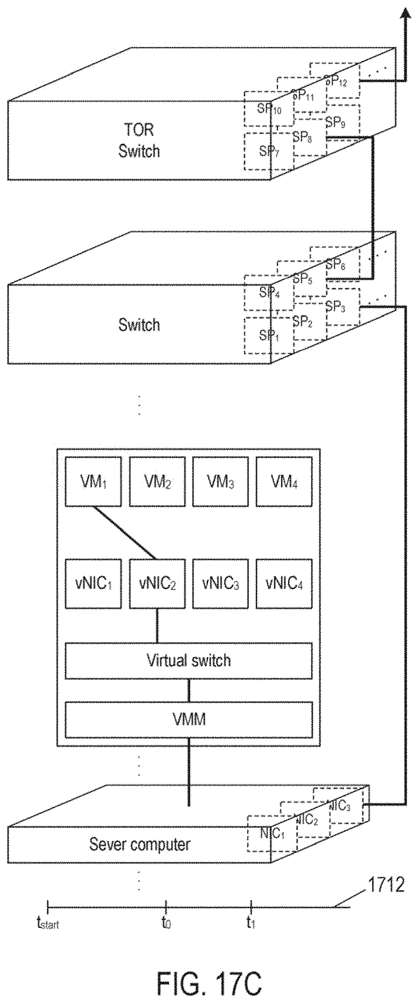

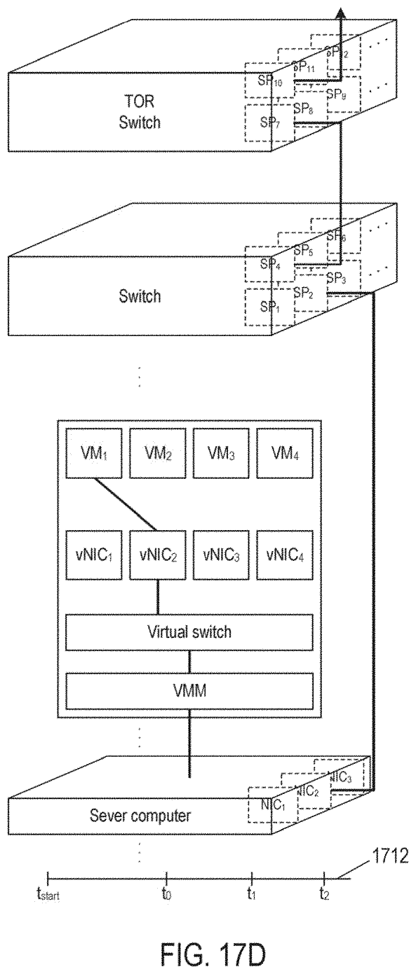

FIG. 17A shows a simple example of network paths for a VM running on a host server computer 1702 in a data center. The host 1702 may be one of numerous server computers located in a rack of server computers (not shown) in the data center. In this example, the host 1702 includes three network interface cards (“NICs”) denoted by NIC₁, NIC₂, NIC₃, and NIC₄. The host 1702 runs four VMs denoted by VM₁, VM₂, VM₃, and VM₄, four virtual NICs (“vNICs”) denoted by vNIC₁, vNIC₂, vNIC₃, and vNIC₄, a virtual switch 1704, and a VMM 1706. The rack includes a switch 1708 and a top of rack (“TOR”) switch 1710. The switch 1708 and TOR switch 1710 include numerous switch ports denoted by SPₙ, where n=1, 2, . . . , 6 identify switch ports of the switch 1708 and n=7, 8, . . . , 12 identify switch ports of the TOR switch 1710. Optical or ethernet cables (not shown) connect the NICs of the host 1702 to SPs of the switch 1708 and similar cables connect switch ports of the switch 1708 to switch ports of the TOR switch 1710. Cables also connect switch ports of the TOR switch 1710 to an aggregator switch (not shown) or to ports of a router (not shown). Dashed lines represent various network paths the VM₁ uses to send and receive data from objects outside the rack.

FIGS. 17B-17D show an example of how three example network paths for sending and receiving data by the VM₁ change over time. FIGS. 17A-17C include a time axis 1712 that begins with a start time denoted by tₛₜₐᵣₜ Solid lines represent network paths between the VM₁ and switch ports of the TOR switch 1710. In FIG. 17A, for a time interval (tₛₜₐᵣₜ,t₀) 1714, VM₁ uses a network path that includes vNIC₁, NIC₁, SP₁, SP₄, SP₇, and SP₁₀. In FIG. 17B, for a time interval (t₀,t₁) 1716, VM₁ uses a network path that includes vNIC₂, NIC₃, SP₃, SP₅, SP₈, and SP₁₂. In FIG. 17C, for a time interval (t₁,t₂) 1718, VM₁ uses a network path that includes vNIC₂, NIC₂, SP₂, SP₄, SP₇, and SP₁₀.

A time-aware model maintains a record of the objects in use on the network paths at different points in time called “time stamps.” The time-aware model is stored in a database of a data storage device and is accessed using a resolving function, as described below, to fetch information regarding which versions of objects of an object type were in use at different time stamps. For example, with reference to FIGS. 17B-17D, suppose the time-aware model is queried with a resolving function to fetch objects of an object type, such as switch ports of the TOR switch. The resolving function returns the objects SP₇, SP₈, SP₁₀, and SP₁₂ and returns the corresponding time stamps that identify when the switch ports SP₇, SP₈, SP₁₀, and SP₁₂ were used.

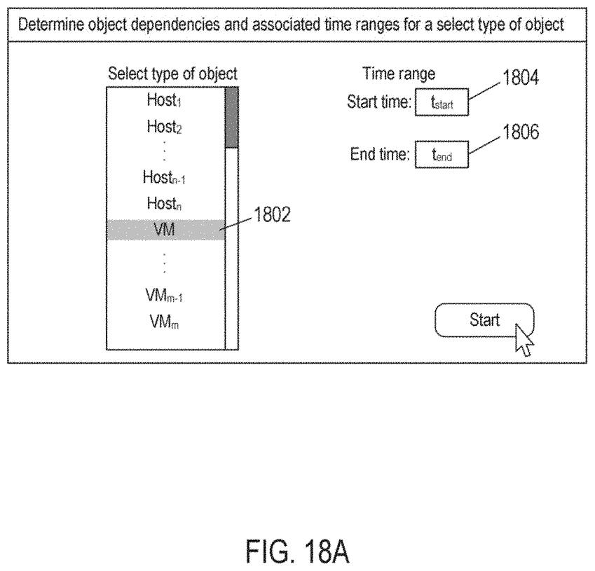

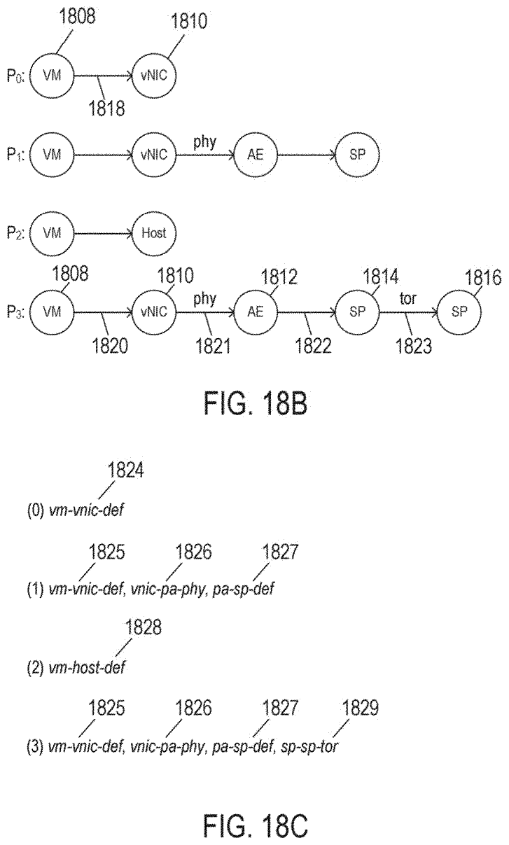

A selected source object type and time interval may be input via a graphical user interface (“GUI”). FIG. 18A shows an example GUI that enables a user to select a source object type from a list of data center object types and input a start time tₛₜₐᵣₜ and an end time t_{end} for the time interval (tₛₜₐᵣₜ-t_{end}). Suppose an alert has been generated indicating that memory usage, CPU usage, throughput, or data packet drops of a VM violates a corresponding threshold at a time tₚ. The GUI enables the user to select the VM 1802 that represents the source object type and includes fields 1804 and 1806 that enable the user to input a corresponding start time tₛₜₐᵣₜ and end time t_{end}, where time tₚ lies within the time interval (tₛₜₐᵣₜ-t_{end}). For example, the source object type may be a VM that executes an application component of a distributed application. There may be more than one instance of the VM object type used in different subintervals of the time interval (tₛₜₐᵣₜ-t_{end}). For example, a first instance of the VM object type may be executed in a first subinterval of the time interval (tₛₜₐᵣₜ-t_{end}). A second instance of the VM object type may be executed in a second subinterval of the time interval (tₛₜₐᵣₜ-t_{end}). Each instance of an object type is an object. In this example, the user initiates computer-implemented methods for determining object dependencies of the selected source object type by selecting start in the GUI.

Computer-implemented methods and systems retrieve pre-generated network paths of a selected object type from a database for the time interval (tₛₜₐᵣₜ-t_{end}). The network paths of the selected source object type are retrieved from the database that maintains the time-aware model of the network. Each network path is traversed as described below to construct a trie data structure of object types that are located on the network paths and send data to and/or receive data from the selected source object type. Each network path comprises consecutive edges between nodes that enables retrieval of the destination objects from the database that maintains the time-aware model. Each edge of a network path is defined by a source object type, a destination object type, and a label.

FIG. 18B shows an example of four separate network paths for the selected type of object VM 1802 in the GUI of FIG. 18A. The separate network paths are pre-generated paths of the time-aware model of the network used by the selected VM object type. Each path comprises a series of nodes separated by edges. The nodes are denoted by labeled circles that represent source object types and destination object types located along each network path. For example, node 1808 represents the selected source object type labeled VM 1802, node 1810 represents one or more vNIC object types, node 1812 represents one or more anchor entity object types, nodes 1814 and 1816 represents switch port object types. In other words, the nodes of the separate network paths represent different object types the selected source object type depends on for sending and receiving data. Edges represented by directional arrows between nodes indicate dependencies between object types. In this example, the four paths obtained for the selected source object type VM 1802 in the time interval (tₛₜₐᵣₜ-t_{end}) are denoted by P₀, P₁, P₂, and P₃, where subscripts correspond to network path indices. The selected source object type VM 1802 is represented as a first node 1808 in each of the network paths. The other nodes represent dependent object types of the selected source object type. For example, network path P₀ has a path index “0” and includes a node 1810 that represents vNIC object type that receives data from, or sends data to, the node 1808 in subintervals of the time interval (tₛₜₐᵣₜ-t_{end}). Edge 1818 represents one or more network connections between the selected source object type represented by node 1808 and the vNIC object type represents by node 1804. Nodes with the same labels in the different network paths represent the same object types. For example, network path P₃ includes node 1808, which represents the selected source object type VM 1802, and node 1810, which represents the vNIC object types in network path P₀. For network path P₃, node 1810 is a destination object type with respect to node 1808 and a source object type with respect to the type of object represented by node 1812. Edges 1820-1823 represent paths of data sent from the node 1808 to dependent object types along the network path P₃. Edge 1821 is labeled “phy” to represent a physical network connection used to send data to, or receive data from, the anchor entity type of object represented by node 1812. Edge 1823 is labeled “tor” to represent a physical network connection to switch ports of a TOR switch.

Computer-implemented methods and systems translate each edge between nodes of a network path into an edge identification (“edge ID”) using a combination the source object type, destination object type, and label of the nodes at opposite ends of the edge. An edge ID of an edge located between a source object type A and a destination object type B is denoted by edge ID(A,B)=a−b−lab, where lower case a and b are labels for the source and destination object types A and B, respectively. A default label for the type of edge is denoted by “def.”

FIG. 18C shows examples of edge IDs formed from the edges of the four network paths P₀, P₁, P₂, and P₃ shown in FIG. 18A. Edge ID 1820 identifies the edge 1818 in network path P₀. Edge IDs 1825-1828 identify the corresponding edges in the network path P₁. Edge ID 1828 identifies the edge in the network path P₂. Edge IDs 1825-1828 identify the corresponding edges in the network path P₁. The edge IDs 1825-1828 also identify corresponding edges in the network path P₃. Edge ID 1829 identifies the edge between switch ports of the network path P₃. The edge-IDs are labeled with the default “def” except for the edge ID 1826 labeled with “phy” representing a physical network connection and the edge ID 1829 labeled with “tor” representing a TOR switch.

Computer-implemented methods and systems construct a trie data structure using the set of edge IDs of the network paths. A trie data structure is a specific type of search tree that is used to link dependencies of object types from the source object type. The edge IDs of the network paths are nodes, also called “trie nodes,” of the trie data structure. Construction of a trie data structure begins with insertion of an empty root node that serves as a parent node for other trie nodes added to the trie data structure. Each node of the trie data structure is labeled with an edge ID that records a network connection, or dependency, between a source object type and a destination object type of the network paths P₀, P₁, . . . , Pₙ. The root of the trie data structure is empty and does not represent an edge ID. Construction of depth one nodes of a trie data structure begins with a root node linked to all edge IDs with the selected source object as a source object of the edge IDs. For example, the empty root node is first linked to an edge ID, s−a−def, as follows:

root→s−a−def

where
“→” represents a link between nodes (i.e., edge IDs) in the trie data structure; and
s represents a selected source object type S and a represents a destination object type A of the selected source object type s.
   The trie data structure is constructed so that for any pair of linked edge IDs of the trie data structure, the edge ID located closer to the root has a destination object type that matches the source object type of the other edge ID. In other words, for an edge ID to be added to, or inserted into, a trie data structure, a source object type of the edge ID matches a destination object type of an edge ID already added to the trie data structure. Consider, for example, an edge ID, a−b−def, that has a as a source object type and b as a destination object type. The edge ID a−b−def and is linked to the edge ID s−a−def as follows:

root→s−a−def→a−b−def

A next edge ID added to this branch of the trie data structure will have b as a source object type.

The terms “parent” and “child” are used to describe relationships between edge IDs of a trie data structure. The root node is called a parent node of the trie data structure and all edge IDs descending from the root are called children or child nodes with respect to the root node. For a series of linked edge IDs represented by nodes in a trie data structure, edge IDs located closer to the root are called parents of edge IDs located farther from the root. In the example above, edge ID a−b−def is a child of edge ID s−a−def and edge ID s−a−def is a parent of edge ID a−b−def. Edge IDs of a trie data structure also includes a network path index that corresponds to one of the network paths. In particular, the nodes of a trie data structure are labeled with the network path index.

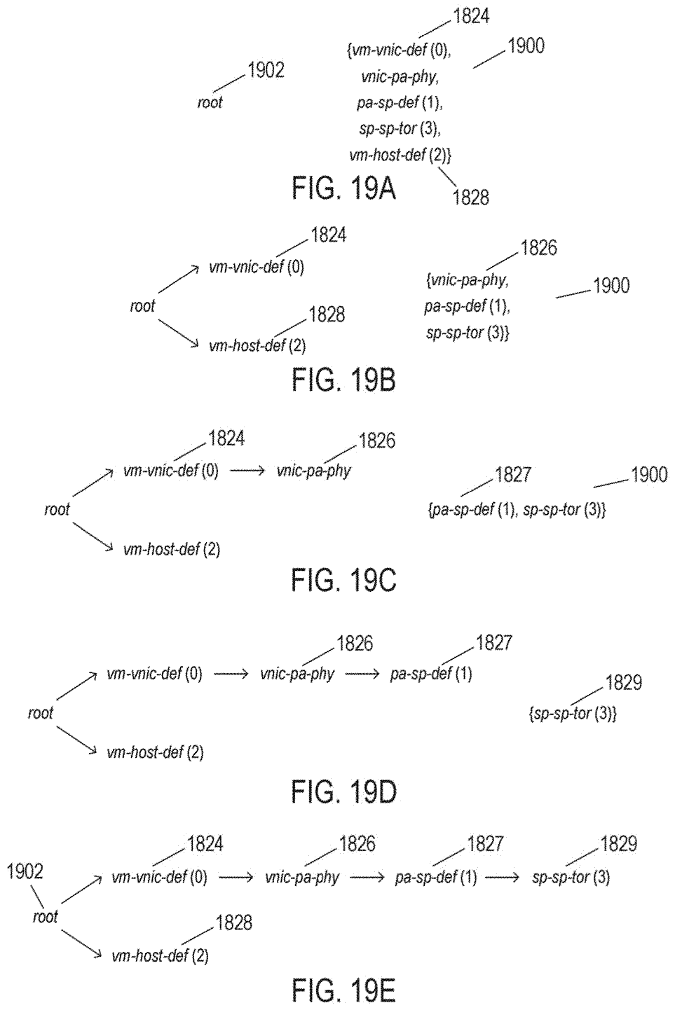

FIGS. 19A-19E show an example of how computer-implemented methods and systems link a set of edge IDs 1900 shown in FIG. 18C to form a trie data structure for the network paths shown in FIG. 18B. Notice that certain edge IDs in the set of edge IDs 1900 include network path indices in parentheses. The edge ID “vnic-pa-phy” does not include a network path index because “pa” corresponds to an anchor entity. In FIG. 19A, formation of the trie data structure begins with an empty root 1902. Edge IDs 1824 and 1829 have the selected source object type VM 1802 as the source object type “vm” and are both linked to the root 1902 as shown in FIG. 19B. The edge IDs 1824 and 1828 are removed from the set of edge IDs 1900. The destination object type of the edge ID 1826 has “pa” as a destination object type and the edge ID 1827 in the set of edge IDs 1900 has “pa” as a source object type. In FIG. 19D, the edge ID 1826 is linked to the edge ID 1826 and removed from the set of edge IDs 1900. The edge ID 1827 has a “sp” as a destination object type and the remaining edge ID 1829 in the set of edge IDs 1900 has “sp” as a source object type. In FIG. 19E, the edge ID 1829 is linked to the edge ID 1826 and removed from the set of edge IDs 1900. Root 1902 is a parent node of the trie data structure constructed from the network paths P₀, P₁, P₂, and P₃. As shown in FIG. 19E, edge IDs 1824 and 1829 contain the selected source object type VM 1802 and are linked directly to the root 1902. Edge IDs 1824, 1826-1829 are linked from the source object type to destination object type. In this example, no other edge IDs descend from the edge IDs 1828 and 1829. Edge IDs 1824, 1827, 1828, and 1829 include the network path indices associated with the network paths P₀, P₁, P₂, and P₃.

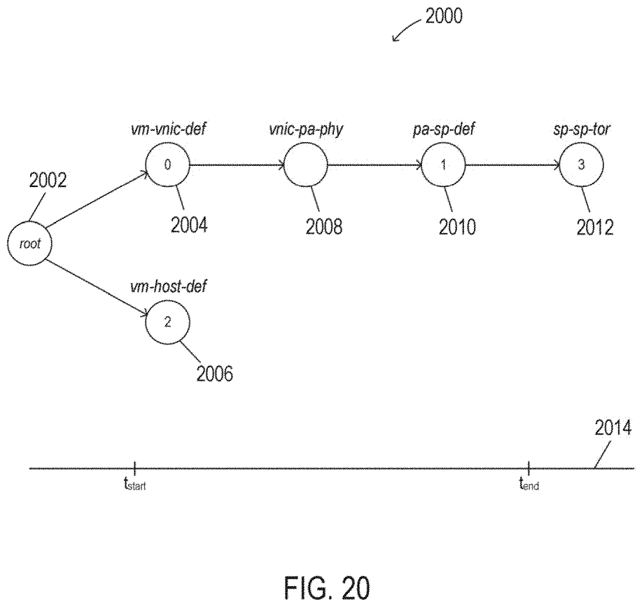

FIG. 20 shows an example trie data structure 2000 with trie nodes that represent the edge IDs of FIG. 19E. The trie data structure 2000 begins with an empty root node 2002. Trie nodes of the trie data structure 2000 represent the edges of the network paths P₀, P₁, P₂, and P₃. For example, trie node 2004 represents edge ID vm-vnic-def, which corresponds to the edges 1818 between the VM object types and the vNIC object types in FIG. 18B. Trie node 2006 represents edge ID vm-host-def, which corresponds to the edge 1820 between the VM object types and host object types in FIG. 18B. The trie nodes 2004 and 2006 are linked to the root 2002. The trie node 2004 is labeled with the network path index “0.” The trie node 2006 is labeled with the network path index “2.” Trie node 2008 represents edge ID vnic-pa-phy, which corresponds to edge 1821 in FIG. 18B, and is not labeled with a network path index. Trie node 2010 represents edge ID pa-sp-def, which corresponds to edge 1822 in FIG. 18B, and is labeled with network path index “1.” Trie node 2012 represents edge ID sp-sp-tor, which corresponds to edge 1823 in FIG. 18B, and is labeled with network path index “3.” FIG. 20 also shows the start time and end time of the time interval (tₛₜₐᵣₜ-t_{end}) located along a time axis 2014. The trie data structure 2000 is used to resolve, in parallel, versions of the source objects and destination objects that are used in subintervals of the time interval (tₛₜₐᵣₜ-t_{end}).

Computer-implemented methods and systems resolve resultant objects for each trie node of the trie data structure by traversing the trie data structure and resolving versions of objects of the object types of each trie node over adjacent subintervals of the time interval (tₛₜₐᵣₜ-t_{end}) In particular, the time interval (tₛₜₐᵣₜ-t_{end}) is partitioned into subintervals based on the different versions of the objects. Computer-implemented methods and system resolve different versions of objects represented by trie nodes located at the same depth from the root node in parallel using resolving functions. A resolving function enables the object versions to be resolved from object types by querying the underlying time-aware model. There can be multiple resolving functions for the same source object type and destination object type. The edge IDs of the trie nodes are used to access the unique resolving function. For example, trie nodes 2004 and 2006 are at depth one from the root node 2002. Trie node 2008 is at depth two from the root node 2002. Trie node 2010 is at depth three from the root node 2002. Trie node 2012 is at depth four from the root node 2002. Because the trie nodes 2004 and 2006 are at the same depth, object versions of the edge IDs represented by nodes 2004 and 2006 are resolved in parallel. The versions of the source object are also resolved in parallel in tₛₜₐᵣₜ-t_{end}) using subintervals of the time interval (the resolving functions that correspond to the edge IDs. The maximum depth of the trie data structure 2000 is four.

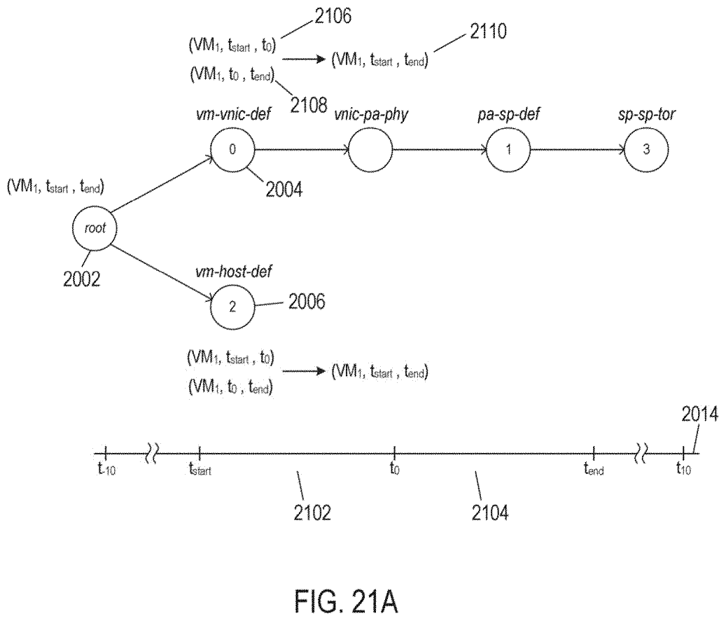

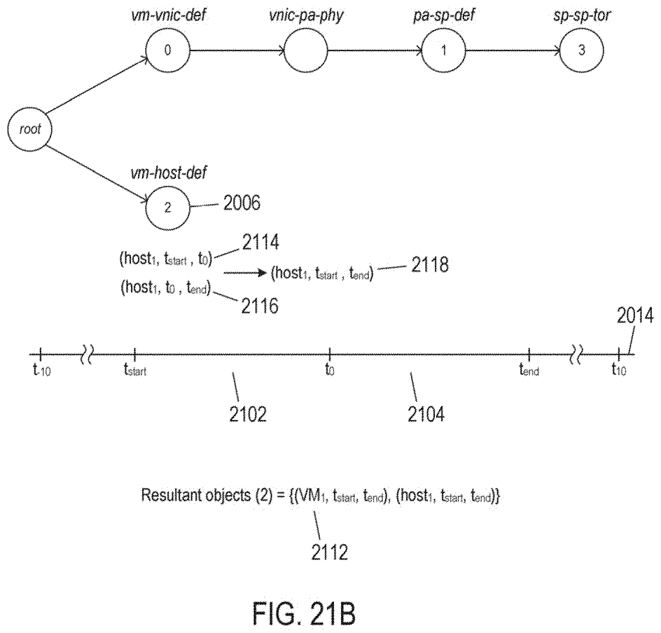

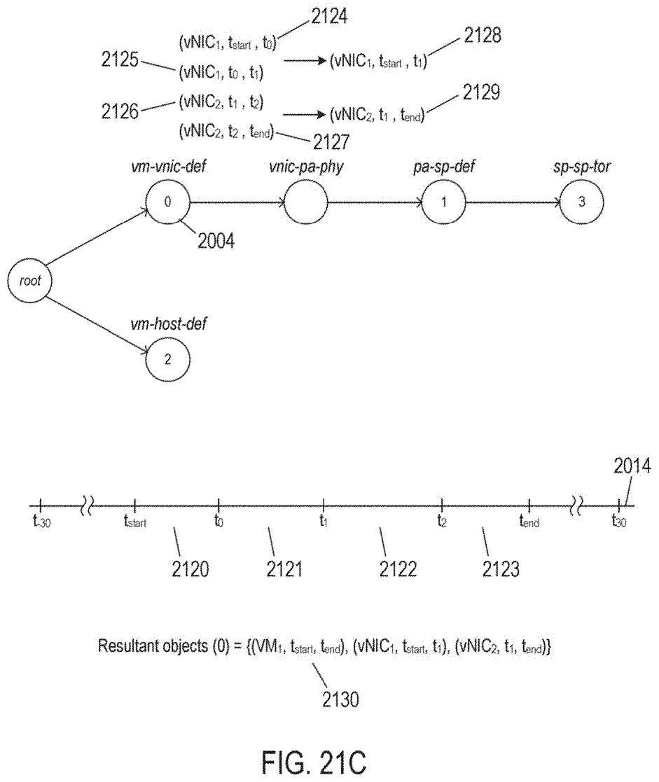

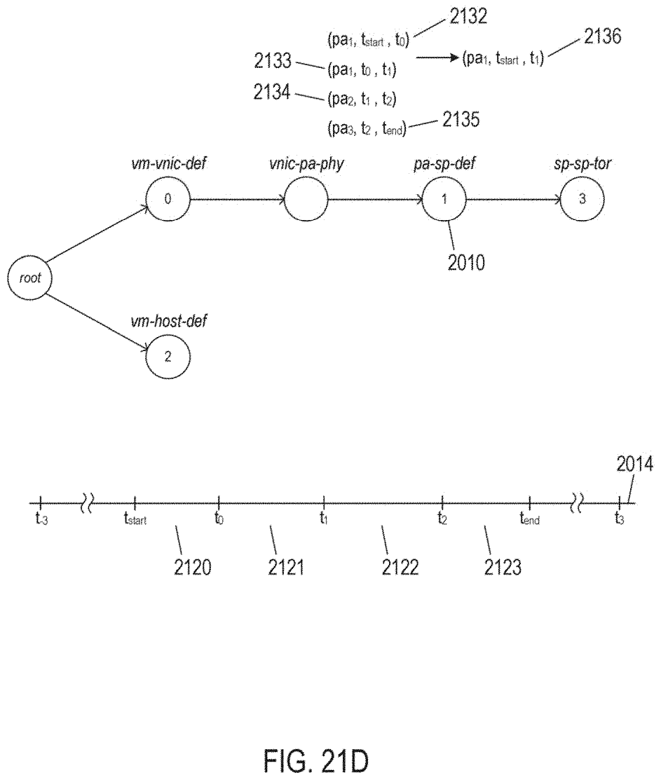

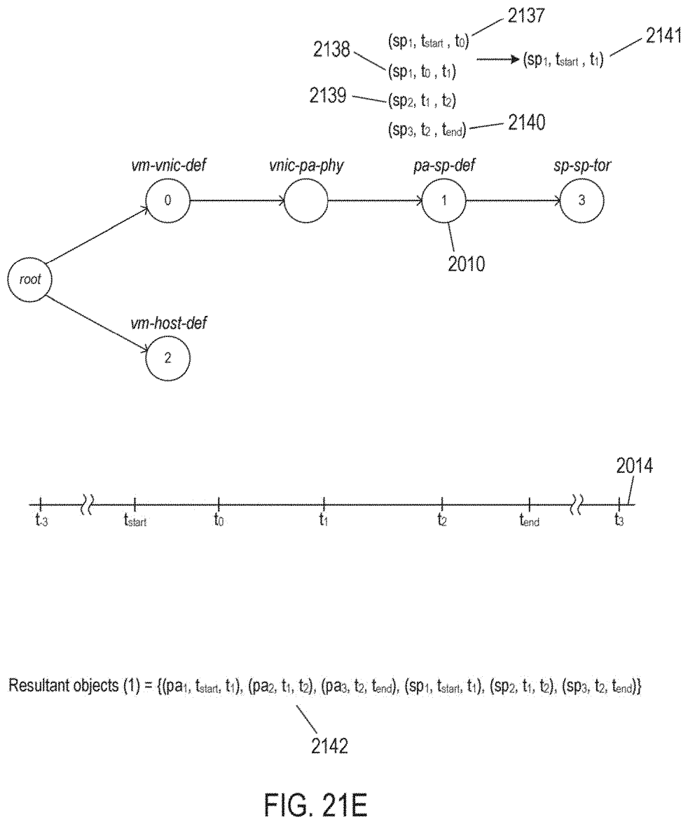

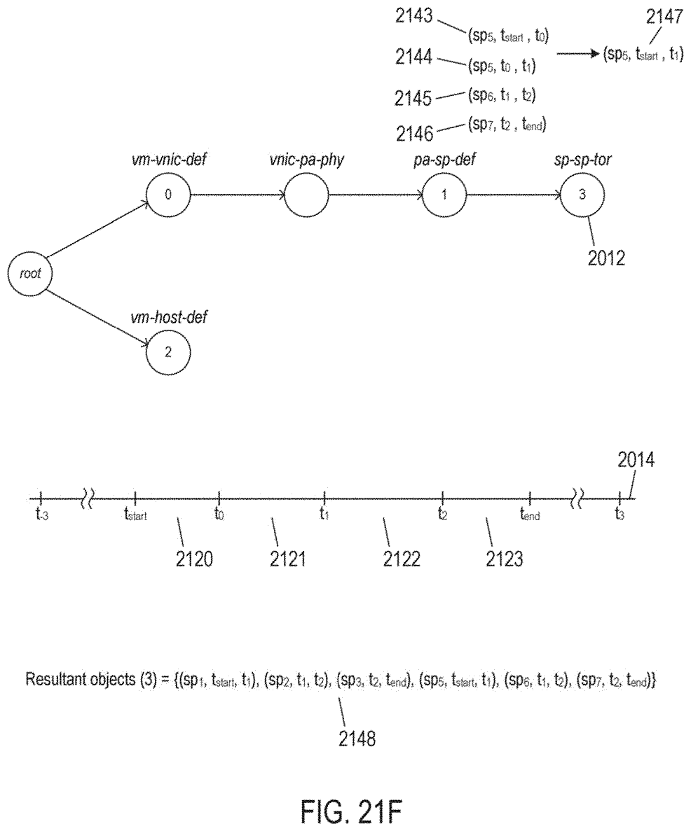

FIGS. 21A-21F show an example of resolving objects of trie nodes of the example trie data structure 2000 over subintervals of the time interval (tₛₜₐᵣₜ-t_{end}) In this example, the root node 2002 corresponds to VM object with version VM₁ and the time interval (tₛₜₐᵣₜ-t_{end}) and is denoted by (VM₁,tₛₜₐᵣₜ,t_{end}) Resolving objects at nodes of the trie data structure begins with depth one trie nodes that are located closest to the root node 2002 and ends with trie nodes located farthest from the root node 2002. The edge IDs of the tried nodes 2004 and 2006 have the same object type as the object VM₁ of the root node 2002.

In FIG. 21A, the sets of resolved objects of the trie nodes 2004 and 2006 are initially empty. Computer-implemented methods and systems fetch resolving functions for the source object type of the edge ID of the trie node 2004. The resolving function of the source object type, vm, fetches versions of the object type vm from the time-aware model. In this example, the results of fetching from the time-aware model reveal the same version of the object, VM₁, recorded at the time stamps t₋₁₀, t₀, and t₁₀. As shown in FIG. 21A, time stamps t₋₁₀ and t₁₀ are located outside the time interval (tₛₜₐᵣₜ-t_{end}). Because the time stamp t₀ is located within the time interval 2014, the time interval is partitioned into two subintervals denoted by (tₛₜₐᵣₜ-t₀) 2102 and (t₀-t_{end}) 2104. The object VM₁ is the same version for the subintervals 2102 and 2104 and is identified as a resolved object for the trie node 2004. The resolved objects and corresponding subintervals are denoted by (VM₁,tₛₜₐᵣₜ,t₀) 2106 and (VM₁,t₀,t_{tend}) 2108. Because the resolved object VM₁ is the same version in adjacent subintervals 2102 and 2104, the subintervals 2102 and 2104 are merged to obtain the resultant object and corresponding time interval (VM₁,tₛₜₐᵣₜ,t_{end}) 2110. The edge ID of the trie node 2006 has the same source object type as the edge ID of the trie node 2004. As a result, resolving the source object type of trie node 2006 gives the same resolved object VM₁ and time interval 2110.

In FIG. 21B, computer-implemented methods and systems fetch resolving functions for the destination object type of the edge ID of the trie node 2006. The resolving function of the destination object type, host, fetches versions of the object type host from the time-aware model. In this example, the results of fetching from the time-aware model reveal the same version of the object, denoted by host₁, is recorded at the time stamps t₋₁₀, t₀, and t₁₀. As shown in FIG. 21B, because the time stamp t₀ is located within the time interval (tₛₜₐᵣₜ-t_{end}), the time interval is partitioned into two subintervals denoted by (tₛₜₐᵣₜ-t₀) 2102 and (t₀-t_{end}) 2104. The resolved objects and corresponding the subintervals are (host₁,tₛₜₐᵣₜ,t₀) 2114 and (host₁,t₀,t_{end}) 2116. The resolved object host₁ is the same version in adjacent subintervals 2102 and 2104. As a result, the subintervals 2102 and 2104 are merged to obtain a resultant object and time interval (host₁,tₛₜₐᵣₜ,t_{end}) 2118. Because the trie node 2006 has a path index “2,” resultant objects and corresponding time intervals (VM₁,tₛₜₐᵣₜ,t_{end}) and (host₁,tₛₜₐᵣₜ,t_{end}) are added to a set of resultant objects 2112 for the path index 2.

In FIG. 21C, computer-implemented methods and systems fetch resolving functions for the destination object type of the edge ID of the trie node 2004. The resolving function of the destination object type, vnic, fetches versions of the object type vnic from the time-aware model. In this example, the results of fetching from the time-aware model reveal two different versions of the object, denoted by vNIC₁ and vNIC₂, recorded at the time stamps t₋₃₀, t₀, t₁, t₂, and t₃₀ from the database. As shown in FIG. 21C, because the three time stamps t₀, t₁, and t₂ are located within the time interval 2014, the time interval (tₛₜₐᵣₜ-t_{end}) is partitioned into four subintervals denoted by (tₛₜₐᵣₜ-t₀) 2120, (t₀-t₁) 2121, (t₁-t₂) 2122, and (t₂-t_{end}) 2123. The object version vNIC₁ is associated with subintervals (tₛₜₐᵣₜ-t₀) 2120 and (t₀-t₁) 2121. The object version vNIC₂ is associated with subintervals (t₁-t₂) 2122, and (t₂-t_{end}) 2123. As a result, the resolved objects and corresponding subintervals are (vNIC₁,tₛₜₐᵣₜ,t₀) 2124, (vNIC₁,t₀,t₁) 2125, (vNIC₂,t₁,t₂) 2126, and (vNIC₂,t₂,t_{end}) 2127. The object version vNIC₁ is the same for adjacent subintervals 2120 and 2121. As a result, the subintervals 2120 and 2121 are merged to obtain resolved object and corresponding subinterval (VNIC₁,tₛₜₐᵣₜ,t₁) 2128. The object version vNIC₂ is the same for adjacent subintervals 2122 and 2123. As a result, the subintervals 2122 and 2123 are merged to obtain resolved object and corresponding subinterval (vNIC₂,t₁,t_{end}) 2129. Because the trie node 2004 has a path index “0,” resultant objects and corresponding time intervals (VM₁,tₛₜₐᵣₜ,t_{end}), (VNIC₁,tₛₜₐᵣₜ,t₁) and (vNIC₂,t₁,t_{end}) are added to a set of resultant objects 2130 for the path index 0.

The process described above with reference to FIGS. 21A-21C is repeated for the edge IDs of nodes 2008, 2010, and 2012. Note that because the trie node 2008 does not have a path index, resolved objects associated with the node 2008 are not stored in a set of resultant objects 2112. Resolving functions are used to fetch versions and time stamps of the source and destination object types of the edge IDs represented by the trie nodes 2008-2012 from the time-aware model. In FIG. 21D, the resolved objects and corresponding subintervals 2120-2123 are (pa₁,tₛₜₐᵣₜ,t₀) 2132, (pa₁,t₀,t₁) 2133, (pa₂,t₁,t₂) 2134, and (pa₂,t₂,t_{end}) 2135. Because the object version pa₁ is the same version in adjacent subintervals 2120 and 2121, the subintervals 2120 and 2121 are merged to obtain resolved object and corresponding subinterval (pa₁,tₛₜₐᵣₜ,t₁) 2136. In FIG. 21E, the resolved objects obtained for the subintervals 2120-2123 are (sp₁,tₛₜₐᵣₜ,t₀) 2137, (sp₁,t₀,t₁) 2138, (sp₂,t₁,t₂) 2139, and (sp₂,t₂,t_{end}) 2140. Because the object version sp₁ is the same version in adjacent subintervals 2120 and 2121, the subintervals 2120 and 2121 are merged to obtain resolved object and corresponding subinterval (sp₁,tₛₜₐᵣₜ,t₁) 2141. Because the trie node 2010 has a path index “1,” resultant objects and corresponding time intervals (pa₁,tₛₜₐᵣₜ,t₁), (pa₂,t₁,t₂), (pa₂,t₂,t_{end}), (sp₁,tₛₜₐᵣₜ,t₁), (sp₂,t₁,t₂), and (sp₂,t₂,t_{end}) are added to a set of resultant objects 2142 for the path index 1. In FIG. 21F, the resolved source objects obtained for the subintervals 2120-2123 are the same as the destination objects obtained for node 2010 (sp₁,tₛₜₐᵣₜ,t₁) 2141, (sp₂,t₁,t₂) 2139, and (sp₂,t₂,t_{end}) 2140. The destination objects are (sp₅, tₛₜₐᵣₜ,t₀) 2143, (sp₅,t₀,t₁) 2144, (sp₆,t₁,t₂) 2145, and (sp₇,t₂,t_{end}) 2146. Because the object version sp₅ is the same version in adjacent subintervals 2120 and 2121, the subintervals 2120 and 2121 are merged to obtain resolved object and subinterval (sp₅,tₛₜₐᵣₜ,t₁) 2147. Because the trie node 2012 has a path index “3,” resultant objects (sp₁,tₛₜₐᵣₜ, t₁), (sp₂,t₁,t₂), (sp₂,t₂,t_{end}), (sp₅,tₛₜₐᵣₜ,t₁), (sp₆,t₁,t₂), and (sp₇,t₂,t_{end}) are added to the set of resultant objects 2148.

Computer-implemented methods and systems retrieve the resolved objects in the set of resultant objects stored in a resultant objects database of data storage device and used to construct a graph with the selected object as the root of the graph and the resolved objects as leaf nodes of the graph. The graph and corresponding subintervals of the resolved objects are displayed in a GUI.

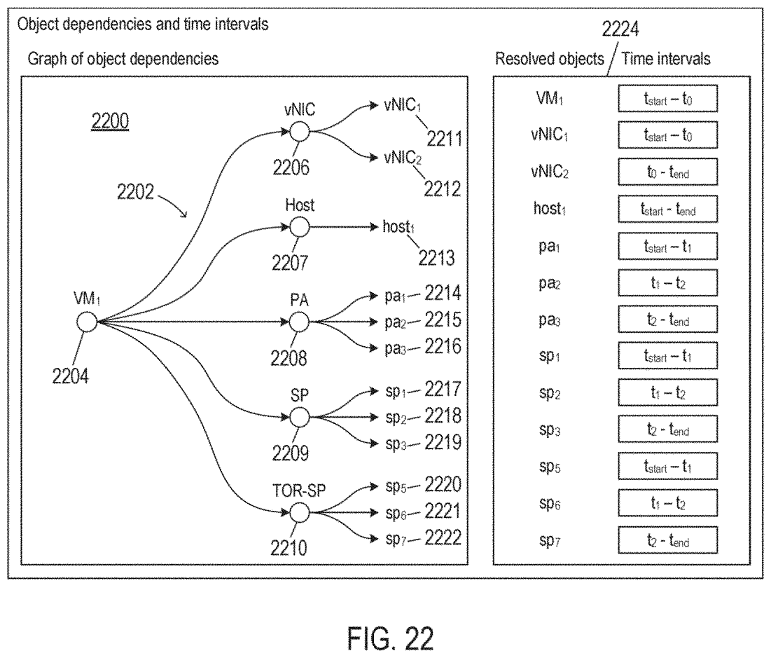

FIG. 22 shows an example GUI that displays an example graph of dependent objects of the selected VM₁ 1802. Window 2200 displays a graph 2202 with the selected object VM₁ 1802 as root node 2204, object types vNIC, Host, PA, SP, and TOR-SP of the network paths P₀, P₁, P₂, and P₃ are intermediate nodes 2206-2210, and the different versions of the resolved objects vNIC₁, vNIC₂, host₁, pa₁, pa₂, pa₃, sp₁, sp₂, sp₃, sp₅, sp₆, and sp₇ obtained from resolving the objects types are displayed as corresponding leaves 2211-2222 of the graph 2202. The example GUI includes a window 2224 that list the resolved objects and corresponding subintervals in which the resolved objects are utilized. For example, the subintervals correspond to subintervals to the resolved objects stored in the resultant objects database.

The graph 2202 and subintervals can be used in troubleshooting to determine which resolved objects of the selected source object were utilized during a problem incident. For example, suppose a problem incident associated with the selected object such as a sharp increase in dropped packets or spike in CPU usage or memory, occurred at a time t_{prob}. Computer-implemented methods and systems determine that the time t_{prob} lies within the subintervals (t₀-t_{end}) and (t₂-t_{end}). Computer-implemented methods and systems identify the resolved objects that were utilized in the subintervals (t₀-t_{end}) and (t₂-t_{end}) are vNIC₂, host₁, pa₃, sp₃, and sp₇. Log messages and metrics associated with each of the resolved objects vNIC₂, host₁, pa₃, sp₃, and sp₇ may be checked to determine which of the resolved objects experienced a network problem. If the problem is with the host₁ or the vNIC₂ running on the Host, remedial measures may include automatically migrating the selected object VM₁ to a different host or simply restarting the host₁. Alternatively, when the problem is with switch port sp₃, the switch port sp₃ may be faulty and data may be rerouted from the selected object VM₁ to a different switch port of the switch or to a different switch of the stack.

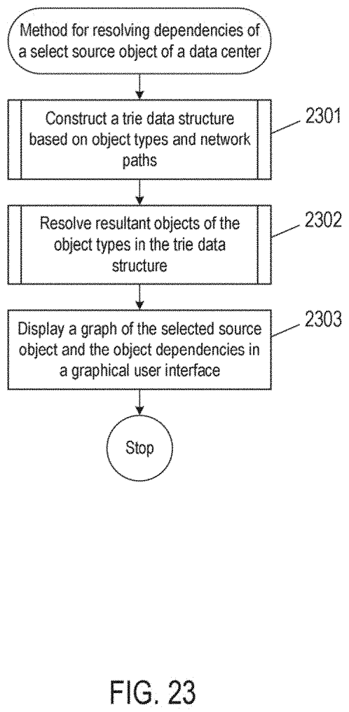

The methods described below with reference to FIGS. 23-26 are stored in one or more data-storage devices as machine-readable instructions and are executed by one or more processors of the computer system shown in FIG. 1.

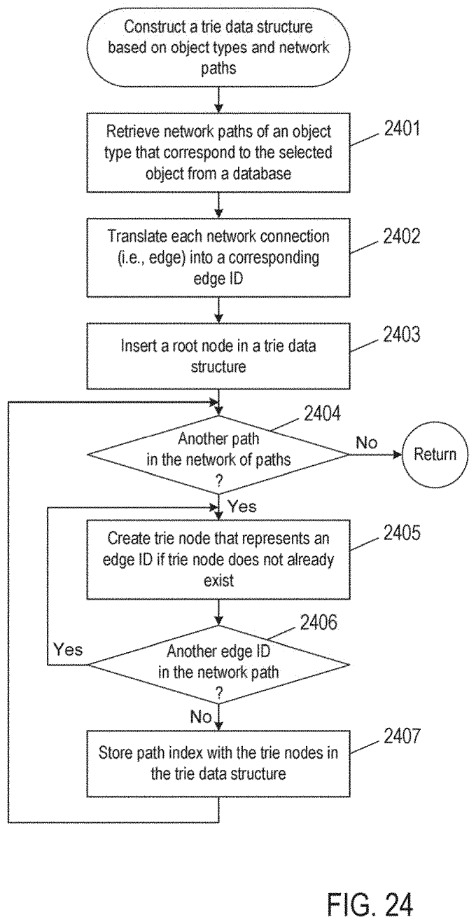

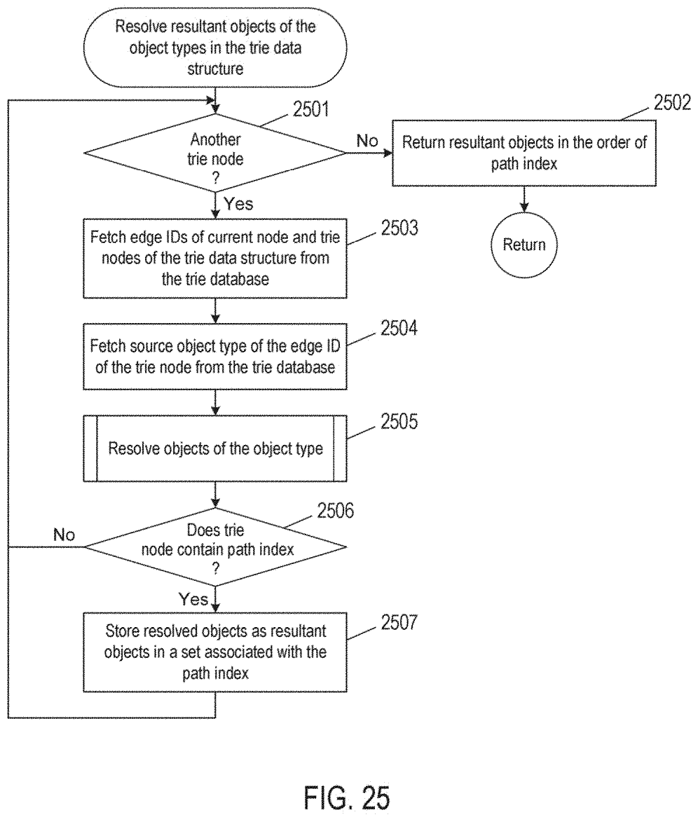

FIG. 23 is a flow diagram of a method for resolving dependencies of a selected source object of data center. In block 2301, a “construct a trie data structure based on object types and network paths” procedure is performed. An example implementation of the “construct a trie data structure based on object types and network paths” procedure is described below with reference to FIG. 24. In block 2302, a “resolve resultant objects of the object types in the trie data structure” procedure is performed. An example implementation of the “resolve resultant objects of the object types in the trie data structure” procedure is described below with reference to FIG. 25. In block 2303, a graph of the selected source object and object dependencies of is generated and stored in a GUI. The method includes troubleshooting to determine which resolved objects of the object dependencies were utilized during a problem incident.

FIG. 24 is a flow diagram illustrating an example implementation of the “construct a trie data structure based on object types and network paths” procedure performed in block 2301 of FIG. 23. In block 2401, network paths of an object type that corresponds to the selected object are retrieved from a database of network paths of a data center as described above with reference to FIG. 18B. In block 2402, each network connection, or edge, between nodes of the network paths is translated into a corresponding edge ID as described above with reference to FIG. 18C. In block 2403, a root node is inserted to start formation of a trie data structure as described above with reference to FIGS. 19A and 20. In decision block 2404, while there are network paths in the network of paths obtained in block 2401, control flows to block 2405. Otherwise, control flows to the flow diagram in FIG. 23. In blocks 2405 and 2406, for each edge ID obtained in block 2402, a trie node is added to the trie data structure as described above with reference to FIGS. 19B-19E to obtain a trie data structure, such as the trie data structure shown in FIG. 20. The trie data structure is stored in a trie databased of a data storage device. In block 2407, the path index is stored with the trie nodes in the trie data structure as described above with reference to FIG. 20.

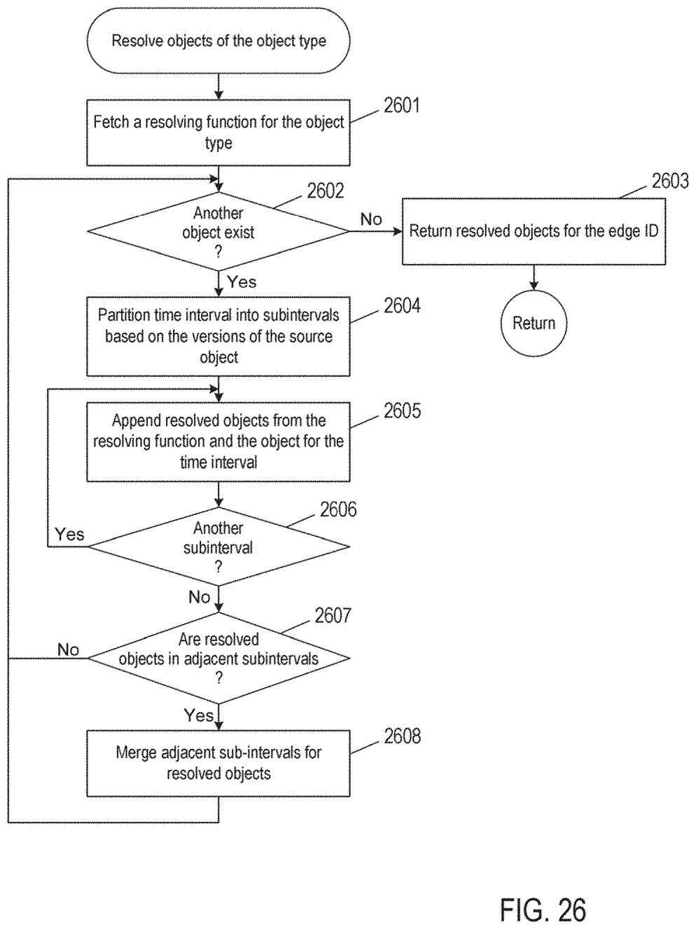

FIG. 25 is a flow diagram illustrating an example implementation of the “resolve resultant objects of the object types in the trie data structure” procedure performed in block 2302 of FIG. 23. In decision block 2501, control flows to block 2504 for each of the trie nodes of the trie data structure. Otherwise, control flow to block 2503. In block 2502, the edge IDs of the current node and trie nodes of the trie data structure are fetched from the trie database. In block 2504, the source object type of the edge ID of the trie node is fetched from the trie database. In block 2505, a “resolve objects of the object type” procedure is performed. An example implementation of the “resolve objects of the object type” procedure is described below with reference to FIG. 26. In decision block 2506, when the trie node contains a corresponding path index, control flows to block 2507. Otherwise, control flows to decision block 2502 and the operations represented by blocks 2504-2506 are repeated for another trie node of the trie data structure. In block 2503, resultant objects are returned in the order of the path index.

FIG. 26 is a flow diagram illustrating an example implementation of the “resolve objects of the object type” procedure performed in block 2505 of FIG. 25. In block 2601, a resolving function is fetched for the object type. In decision block 1602, when an object is obtained by the resolving function control flows to block 2604. Otherwise, control flows to block 2603. In block 2604, the time interval is partitioned into subintervals based on the different versions of the object as described above with reference to FIG. 21A-21. In block 2605, the resolved objects from the resolving function and the object for the time interval are appended. In decision block 2606, block 2605 is repeated for each of the subintervals. In decision block 2607, when the resolved objects are in adjacent subintervals, control flows to block 2608. Otherwise, control flows block 2602. In block 2608, adjacent subintervals are merged for resolved objects as described above with reference to FIGS. 21A-21F. In block 2603, resolved object are returned for the edge ID of the trie node.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein

What is claimed is:

1. A method stored in one or more data-storage devices and executed using one or more processors of a computer system for determining object dependencies of a selected source object of a data center, the method comprising:
obtaining a selected source object and a time interval via a graphical user interface displayed on a monitor;
constructing a trie data structure of object types located along network paths utilized by the selected object in the time interval;
resolving resultant objects of the object types in the trie data structure, the resultant objects corresponding to subintervals of the time interval in which the resultant objects are used by the selected object;
generating a graph of the selected source object and resultant objects; and
troubleshooting network performance problems associated with the selected object based on the graph and subintervals that correspond to when the selected object used the resultant objects.

2. The method of claim 1 wherein constructing the trie data structure of object types comprises:
retrieving network paths of an object type that corresponds to the selected source object from a database of network paths of a data center;
translating each network connection between nodes of the network paths into a corresponding edge ID;
for each edge ID, creating a trie node in a trie data structure stored in a trie structure database; and
for each network path, storing a path index with corresponding trie nodes of the trie data structure.

3. The method of claim 1 wherein resolving the resultant objects of the object types in the trie data structure comprises:
fetching edge IDs of a root node and trie nodes of the trie data structure from the trie structure database; and
for each of the trie node,
fetching an object type of the edge ID of the trie node from the trie structure database, and
resolving objects of the object type to obtain resultant objects.

4. The method of claim 3 wherein resolving objects of the object type to obtain the resultant objects comprises:
fetching a resolving function for the object type;
using the resolving function to fetch versions of an object of the object type and time stamps associated with each version from a time-aware model;
partitioning the time interval into subintervals based on the versions of the object; and
merging adjacent subintervals when the objects are the same for adjacent subintervals, wherein the objects with corresponding subintervals are the resolved objects.

5. The method of claim 1 wherein resolving the resultant objects of the object types in the trie data structure comprises:
traversing the trie data structure; and
resolving each trie node of the trie data structure into resolved objects, each resolved object corresponding to an object type of a trie node and corresponding to a subinterval of the time interval.

6. The method of claim 1 wherein troubleshooting network performance problems associated with the selected object comprises identifying resolved objects used by the selected source object and the subintervals of the time interval in which the resolved objects were used by the selected object.

7. The method of claim 1 further comprising executing remedial measures to correct the network performance problem.

8. A computer system for determining object dependencies of a selected object of a data center, the system comprising:
one or more processors;
one or more data-storage devices; and
machine-readable instructions stored in the one or more data-storage devices that when executed using the one or more processors controls the system to execute operations comprising:
obtaining a selected source object and a time interval via a graphical user interface displayed on a monitor;
constructing a trie data structure of object types located along network paths utilized by the selected object in the time interval;
resolving resultant objects of the object types in the trie data structure, the resultant objects corresponding to subintervals of the time interval in which the resultant objects are used by the selected object;
generating a graph of the selected source object and resultant objects; and
troubleshooting network performance problems associated with the selected object based on the graph and subintervals that correspond to the resultant objects.

9. The system of claim 8 wherein constructing the trie data structure of object types comprises:
retrieving network paths of an object type that corresponds to the selected source object from a database of network paths of a data center;
translating each network connection between nodes of the network paths into a corresponding edge ID;
for each edge ID, creating a trie node in a trie data structure stored in a trie structure database; and
for each network path, storing a path index with corresponding trie nodes of the trie data structure.

10. The system of claim 8 wherein resolving the resultant objects of the object types in the trie data structure comprises:
fetching edge IDs of a root node and trie nodes of the trie data structure from the trie structure database; and
for each of the trie node,
fetching an object type of the edge ID of the trie node from the trie structure database, and
resolving objects of the object type to obtain resultant objects.

11. The system of claim 10 wherein resolving objects of the object type to obtain the resultant objects comprises:
fetching a resolving function for the object type;
using the resolving function to fetch versions of an object of the object type and time stamps associated with each version from a time-aware model;
partitioning the time interval into subintervals based on the versions of the object; and
merging adjacent subintervals when the objects are the same for adjacent subintervals, wherein the objects with corresponding subintervals are the resolved objects.

12. The system of claim 8 wherein resolving the resultant objects of the object types in the trie data structure comprises:
traversing the trie data structure; and
resolving each trie node of the trie data structure into resolved objects, each resolved object corresponding to an object type of a trie node and corresponding to a subinterval of the time interval.

13. The system of claim 8 wherein troubleshooting network performance problems associated with the selected object comprises identifying resolved objects used by the selected source object and the subintervals of the time interval in which the resolved objects were used by the selected object.

14. The system of claim 8 further comprising executing remedial measures to correct the network performance problem.

15. A non-transitory computer-readable medium encoded with machine-readable instructions that causes one or more processors of a computer system to perform operations comprising:
obtaining a selected source object and a time interval via a graphical user interface displayed on a monitor;
constructing a trie data structure of object types located along network paths utilized by the selected object in the time interval;
resolving resultant objects of the object types in the trie data structure, the resultant objects corresponding to subintervals of the time interval in which the resultant objects are used by the selected object;
generating a graph of the selected source object and resultant objects; and
troubleshooting network performance problems associated with the selected object based on the graph and subintervals that correspond to the resultant objects.

16. The medium of claim 15 wherein constructing the trie data structure of object types comprises:
retrieving network paths of an object type that corresponds to the selected source object from a database of network paths of a data center;
translating each network connection between nodes of the network paths into a corresponding edge ID;
for each edge ID, creating a trie node in a trie data structure stored in a trie structure database; and
for each network path, storing a path index with corresponding trie nodes of the trie data structure.

17. The medium of claim 15 wherein resolving the resultant objects of the object types in the trie data structure comprises:
fetching edge IDs of a root node and trie nodes of the trie data structure from the trie structure database; and
for each of the trie node,
fetching an object type of the edge ID of the trie node from the trie structure database, and
resolving objects of the object type to obtain resultant objects.

18. The medium of claim 17 wherein resolving objects of the object type to obtain the resultant objects comprises:
fetching a resolving function for the object type;
using the resolving function to fetch versions of an object of the object type and time stamps associated with each version from a time-aware model;
partitioning the time interval into subintervals based on the versions of the object; and
merging adjacent subintervals when the objects are the same for adjacent subintervals, wherein the objects with corresponding subintervals are the resolved objects.

19. The medium of claim 15 wherein resolving the resultant objects of the object types in the trie data structure comprises:
traversing the trie data structure; and
resolving each trie node of the trie data structure into resolved objects, each resolved object corresponding to an object type of a trie node and corresponding to a subinterval of the time interval.

20. The medium of claim 15 wherein troubleshooting network performance problems associated with the selected object comprises identifying resolved objects used by the selected source object and the subintervals of the time interval in which the resolved objects were used by the selected object.

21. The medium of claim 15 further comprising executing remedial measures to correct the network performance problem.
